(19) United States
(12) Patent Application Publication
(10) Pub. No.: US 2026/0024035 A1
(43) Pub. Date: Jan. 22, 2026

(54) SELECTING AUTOMATED TELLER MACHINE DISTRIBUTION USING ARTIFICIAL INTELLIGENCE AND PREDICTIVE ANALYTICS

(71) Applicant: Wells Fargo Bank, N.A., San Francisco, CA (US)

(72) Inventors: Frank A. DiGangi, Statesville, NC (US); James Merritt Fordham, III, Fort Lauderdale, FL (US); Elizabeth Ann Schrag, Walnut Creek, CA (US); Kristen C. Trogdon, Asheboro, NC (US)

(21) Appl. No.: 18/776,355

(22) Filed: Jul. 18, 2024

(51) Int. Cl. G06Q 10/0631; G06Q 30/0202; G07F 19/00

(52) U.S. Cl. CPC G06Q 10/06315; G06Q 30/0202; G07F 19/20

(57) ABSTRACT

Various examples are directed to systems, methods, and computer programs for selecting a location for automated teller machine (ATM) placement. The system comprises collecting ATM usage data and integrating this data with external data linked to the zip codes of ATM users, thereby creating a comprehensive dataset. Utilizing an artificial intelligence model to implement predictive techniques to identify an optimal location for a new or relocated ATM. The system comprises generating an output that specifies the updated ATM distribution point. The system enhances the strategic placement of ATMs based on actual usage patterns and demographic data, aiming to improve service accessibility and operational efficiency.

### TECHNICAL FIELD

The present disclosure generally relates to special-purpose machines that manage financial institution data and databases and, more specifically, to Automated Teller Machine (ATM) distribution point placement using artificial intelligence and predictive analysis.

### BACKGROUND

An automated teller machine (ATM) is an electronic device that enables customers to perform transactions in the absence of human bank tellers, cashiers, or clerks. Activities, such as a cash withdrawal, which are typically performed in a banking branch at a teller station may be performed nearly anywhere in the world where an ATM is able to communicate with a banking branch. Customers may perform a wide variety of transactions at an ATM, including cash withdrawals, deposits, balance reports, print statements, or even purchasing postage stamps. Financial institutions require methods and systems to identify optimal physical locations to select for use for their ATMs.

### BRIEF DESCRIPTION OF THE SEVERAL VIEWS OF THE DRAWINGS

The present disclosure will be apparent from the following more particular description of examples of embodiments of the technology, as illustrated in the accompanying drawings. In the drawings, which are not necessarily drawn to scale, like numerals may describe similar components in different views. Like numerals having different letter suffixes may represent different instances of similar components. To easily identify the discussion of any particular element or act, the most significant digit or digits in a reference number refer to the figure number in which that element is first introduced. Some embodiments are illustrated by way of example, and not limitation, in the figures of the accompanying drawings in which:

FIG. 1 is a diagram illustrating a map of a town with two zip codes, according to some example embodiments.

FIG. 2 is a diagram illustrating an ATM communication system, according to some example embodiments.

FIG. 3 is an example of the ATM distribution artificial intelligence system, according to some example embodiments.

FIG. 4 is a diagram illustrating a customer receipt from an ATM, according to some example embodiments.

FIG. 5 is an example user interface on a mobile device, according to some example embodiments.

FIG. 6 is a flow diagram illustrating a method for selecting a location for automated teller machine (ATM) placement, according to some example embodiments.

FIG. 7 illustrates a machine-learning pipeline, according to some example embodiments.

FIG. 8 is a data flow diagram illustrating training and use of a machine-learning program, according to some example embodiments.

FIG. 9 is a data flow diagram illustrating content generation with generative artificial intelligence, according to some example embodiments.

FIG. 10 is a block diagram showing an example architecture of a user computing device, according to some example embodiments.

FIG. 11 is a block diagram showing one example of a software architecture for a computing device, according to some example embodiments.

FIG. 12 is a block diagram illustrating a computing device hardware architecture, within which a set or sequence of instructions can be executed to cause a machine to perform examples of any one of the methodologies discussed herein, according to some example embodiments.

### DETAILED DESCRIPTION

In the following description, for purposes of explanation, numerous specific details are set forth in order to provide a thorough understanding of some example embodiments. It will be evident, however, to one skilled in the art that the present disclosure may be practiced without these specific details. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

Example systems, methods, computer programs, and machine-readable media described herein are directed to integrating advanced technologies in the field of financial technology, particularly in optimizing ATM placements using artificial intelligence models (e.g., large language models, machine learning models, generative artificial intelligence models, etc.), predictive analytics, and near real-time data processing, to address several common technical problems and challenges known in the prior art. Examples include a system comprising an advanced artificial intelligence (AI) system configured to integrate and analyze diverse data sources, including ATM usage data, customer zip code data, and real estate data. The AI system is configured to generate predictive insights for optimal ATM placements by considering legal and financial constraints, and process incoming data from ATMs and external data (e.g., data obtained from outside the financial institution) sources in real-time. The AI system predicts an optimal ATM location (e.g., an ATM distribution point, placement of an ATM) based on the predictive insights generated. A financial institution can receive the AI system's optimal predictions including identifying an ATM distribution point most likely to bring success or advantage to the financial institution.

In examples, the AI system can identify an existing ATM distribution point being a sub-optimal location for the existing ATM when the ATM distribution point is not bringing success to the financial institution or the customers of the financial institution. For example, when the distribution point is inconvenient for a customer of the financial institution, the AI system can predict that it is sub-optimal. Identifying an optimal real estate location is difficult for human analysts of banking organizations as identifying an ideal (e.g., best, most effective possible in a situation, optimal, etc.) distribution point based on ATM usage metrics require real-time or near real-time data metrics as described throughout. A user interface for the AI system displays the suggested ATM locations to bank operators for decision-making. For example, the AI system employs machine learning algorithms selected from the group consisting of decision trees, neural networks, and clustering algorithms to forecast future demographic and economic changes in potential ATM locations.

Prior systems have addressed ATM placement through basic data analysis and manual decision-making processes, often relying on historical transaction data and demographic studies. These traditional methods are limited in their ability to process large volumes of data in real-time and lack predictive capabilities. While some systems utilize geographic information systems (GIS) for spatial analysis, they do not fully integrate AI for predictive modeling and optimization. For example, traditional methods for ATM distribution often rely on manual analysis and historical data, which may not accurately predict current and future needs, leading to ATMs being placed in locations with low transaction volumes or high operational costs. Prior systems may not adapt quickly to changes in demographics, economic conditions, or customer behavior, which can affect the usage and efficiency of ATM networks. Integrating and managing data from various sources can be complex and error-prone, leading to decisions based on incomplete or inaccurate data. Traditional methods may lack the capability to forecast future trends effectively, leading to reactive rather than proactive ATM placement strategies. Ensuring compliance with zoning laws, financial regulations, and data privacy laws can be challenging and resource intensive. ATMs may not be placed optimally for user convenience, potentially leading to customer dissatisfaction and reduced usage. Misallocation of ATMs can lead to underused resources or areas with excessively high demand that cannot be met efficiently. The effectiveness of ATM placement decisions is heavily dependent on the timely analysis of data to make real-time decisions. Delays in data processing could lead to missed opportunities or suboptimal decisions. Existing systems may lack advanced predictive capabilities, relying instead on basic data analysis and manual decision-making processes. This limitation hinders the ability to optimally place ATMs based on predictive insights. Bank operators need robust support tools to make informed decisions about ATM placements. Existing systems may not provide sufficient or actionable data to operators, making the decision-making process more difficult.

Examples of the present disclosure improve upon existing ATM placement tools and overcome current technical challenges by providing an artificial intelligence (AI) ATM distribution system (also referred to as “the AI system,” or simply “the system”) to analyze customer traffic patterns and real estate data to predict and recommend ATM placements in high-traffic and accessible areas, improving customer satisfaction and accessibility. Additionally, the system can predict and recommend the removal of underperforming ATMs and the addition of new ones in high-demand areas, optimizing resource allocation and operational efficiency. The AI system can obtain customer home data when a customer accesses an ATM in order to drive traffic to a specific ATM distribution point and select real estate locations near partner companies of the financial institution to place the ATM.

The system further solves existing problems given the state of the art in financial technologies, particularly in the areas of artificial intelligence, predictive analytics, and/or near real-time or real-time data processing. The system can integrate internal data (e.g., customer data) and external data (e.g., data obtained from outside the financial institution) into a centralized structure to ensure comprehensive analysis and management, therein enhancing the accuracy and reliability of the data used for decision-making and distribution of ATMs. The AI system (e.g., one or more AI models) used by the present system can receive data from external data sources, such as sources external to the financial institution associated with the ATM. For example, external data sources can include the Internet, external services, data scraping from external resources to retrieve data such as driving traffic patterns, foot traffic patterns, real estate availabilities (e.g., purchases, sales, vacancies, etc.) for residential and commercial properties, construction zones, location (e.g., town, city, etc.) zoning laws and changes, and the like. The internal data can be acquired from the financial institution associated with a customer of the financial institution or from the ATM card of a user of the financial institution's ATM that is a customer of a different financial institution.

Examples of the system utilize artificial intelligence (AI), general artificial intelligence (GenAI), large language models (LLMs), and/or machine learning (ML) algorithms (referred to generally as “artificial intelligence”) to analyze and process internal (e.g., financial institution) data and external (e.g., real estate properties, GIS, zip codes, etc.) data. This can include, for example, the use of decision trees, neural networks, clustering algorithms, or the like to identify patterns in data such as ATM usage, customer zip codes, and real estate information. Examples of the system's use of AI capabilities to integrate and analyze diverse data sources enables the financial institution to predict optimal ATM locations and enhance decision-making processes associated with the placement and/or removal of financial institution ATM locations.

Examples of the system utilize predictive analytics to generate insights for ATM placement by considering various factors, including legal, financial, real estate, usage, and/or additional constraints. The system can predict demographic and economic changes in potential ATM locations, providing a forward-looking approach to optimize ATM distribution for a financial institution. The system can forecast demographic and economic changes, allowing financial institutions to plan for future needs and optimize ATM placements ahead of time. The system's combination of AI and predictive analytics is implemented by a financial institution, an online banking system, or financial service, to analyze real-time and diverse data sources, allowing for more strategic and data-driven placement of ATMs, potentially increasing transaction volumes and reducing operational costs.

Examples of the system incorporate real-time, near real-time, periodic, and/or scheduled data processing capabilities, which are fundamental for handling incoming data from ATMs and external sources in a prompt and timely manner. For example, near real time can include or refer to processing and reporting of data almost immediately after the data is collected, with only a slight delay (e.g., seconds, minutes, hours depending on the data sources). For example, near real-time systems process data so quickly that users perceive it as happening instantaneously, although technically, there is a brief lag-usually seconds or milliseconds. In some examples, this slight delay in near real-time systems can be due to various factors such as the time it takes to transmit data across networks, the processing speed of the system, or the methods used to analyze and report the data. Despite these delays, near real-time systems are typically fast enough for scenarios where immediate data processing is critical but a slight delay is acceptable, such as in monitoring transactions, tracking system performance, or updating user interfaces based on user interactions.

In contrast, real-time data processing is possible when data is collected with no perceptible delay between collection and availability for use by the system. These types of processing allow the system to monitor and respond to changes in ATM usage patterns and customer behaviors dynamically, ensuring that the ATM network adapts to current demands efficiently. Examples of the system provide for dynamic actions or processes to occur automatically and in response to changes or conditions without manual intervention. For example, examples of the system allow for dynamic data collection and data analytics including flexibility and adaptability in adjustments based on current data or events. The real-time data processing unit in the example embodiment allows for immediate response to changes in data, helping banks quickly adapt their ATM network in response to shifting market conditions.

Examples of the AI system are designed to optimize ATM placements using a combination of artificial intelligence and predictive analytics. The AI system is composed of several interconnected engines, each dedicated to specific functions that collectively aim to identify the most suitable locations for new ATMs. These include an AI engine that integrates and analyzes data from various sources such as ATM usage, customer zip codes, and real estate information. It utilizes machine learning algorithms to detect patterns and trends essential for making informed placement decisions. The predictive analytics engine, linked with the AI engine, forecasts demographic and economic changes to provide a forward-looking perspective on potential ATM locations. Additionally, a recommendation engine suggests optimal locations and potential partner stores for ATMs based on these insights and also identifies underperforming ATMs for possible removal.

Examples of the AI system feature a real-time or near real-time data processing engine that handles immediate data inputs from ATMs and external sources, aiding in dynamic decision-making by monitoring usage patterns and customer wait times. An interactive user interface displays these recommendations to bank operators, allowing them to make adjustments based on a comprehensive set of data, ensuring well-rounded final decisions.

Examples of the AI system includes a methodological approach involving the collection and integration of data into a centralized structure, followed by analysis using AI algorithms to generate and display suggested ATM locations. This method extends to include the anonymization of customer data for privacy, the use of multi-criteria decision analysis for evaluating potential locations, and the integration of social media and mobile data to identify emerging hotspots for ATMs.

Examples of the AI system can incorporate geographic information systems (GIS) data to consider zoning restrictions and use econometric models to estimate construction costs, enhancing the decision-making process. Predictive models within the system also simulate future scenarios that might affect ATM viability, allowing the system not only to assess current suitability but also to anticipate and adapt to future trends. This comprehensive approach ensures that the AI system aligns with the strategic goals of financial institutions and adapts to changing market conditions, ultimately facilitating the efficient placement of ATMs based on a robust analysis of multiple data points.

Examples of the AI system utilize artificial intelligence to identify legal and financial constraints when suggesting ATM locations, incorporating features to anonymize data, which helps to ensure compliance with relevant regulations. Using AI, the system can predict where ATMs will be needed in the future. It looks at patterns like how many people use ATMs in different areas and predicts changes, like if a neighborhood is getting more crowded. The system is built to easily integrate and work with the banks' existing technology. For example, banks can start using this new system without needing to make big changes to their current setup, infrastructure, computing systems, or the like. The system has a special interface designed to help bank operators and bank customers make decisions easily by providing useful information clearly and suggesting the best physical locations for new ATMs. In some examples, the system learns over time and uses data from its own recommendations to improve at making future decisions related to ATM distribution.

Examples of the ATM distribution artificial intelligence system can further provide a plethora of additional improvements to existing ATM distribution systems, such as dynamic pricing of ATM transactions, enhanced security and fraud detection, predictive maintenance of ATMs, optimization of cash logistics, and environmental impact optimization. For example, the system can predict dynamic pricing of ATM transactions when there is fluctuating demand for ATM services that lead to inefficiencies in pricing strategies, such as static pricing that may either deter usage during peak times or fail to optimize revenue during off-peak times. Examples can solve this by implementing near real-time or real-time data processing capabilities and predictive analytics of the system could be extended to dynamically adjust transaction fees based on current demand, location, time, or even specific customer profiles, thereby optimizing revenue, and managing demand more effectively. For example, the system can dynamically implement demand-sensitive pricing algorithms based on predictions to implement an algorithm within the AI system that adjusts ATM transaction fees based on real-time demand, location, time data, and the like. The algorithm can use predictive analytics to forecast peak times and adjust pricing accordingly to manage demand and maximize revenue. The system can use machine learning to segment customers based on their transaction behaviors and preferences, allowing for personalized pricing strategies that could encourage usage during off-peak hours through discounts or rewards.

In another example, the system can provide enhanced security and fraud detection because ATMs are frequent targets for fraud and security breaches, which can lead to significant financial losses and erosion of customer trust. The AI system can incorporate anomaly detection algorithms to identify unusual patterns that may indicate fraudulent activities or security threats. By analyzing transaction data in near real-time or real-time, the system can trigger immediate alerts and preventive actions, enhancing the security of ATM operations. For example, the AI system can dynamically provide anomaly detection systems to integrate advanced anomaly detection algorithms within the system to monitor transaction patterns and flag activities that deviate from the norm, which could indicate potential fraud or security breaches. The system can transmit near real-time or real-time alerts to bank operators and security personnel when suspicious activities are detected, enabling quick response to potential threats.

In another example, the system can predict the need for maintenance of ATMs. Traditional maintenance schedules for ATMs are typically reactive or time-based, which can lead to unexpected failures or inefficient use of maintenance resources. The example AI system can utilize predictive analytics to forecast potential ATM failures or maintenance needs based on usage patterns and historical maintenance data. This proactive approach can reduce downtime, extend the lifespan of the machines, and optimize maintenance schedules. The AI system can utilize machine learning models to analyze historical maintenance data and usage patterns to predict when ATMs are likely to require servicing or are at risk of failure. For example, the AI system can create a dynamic scheduling tool within the user interface that helps coordinate maintenance visits based on the predictive analytics, ensuring that ATMs are maintained efficiently with minimal downtime.

In another example, the system can predict and recommend optimization of cash logistics for ATMs. Managing the cash supply in ATMs involves significant logistical challenges and costs, with risks of either stock-outs or excessive cash leading to higher operational costs. The AI system can analyze withdrawal patterns and predict future cash demands at each ATM location, enabling more precise cash management and logistics. This would help in reducing the costs associated with cash transportation and handling, while also ensuring that ATMs are adequately stocked to meet customer needs. For example, the system can implement models that predict cash requirements at individual ATMs, analyzing factors such as historical withdrawal patterns, local events, and economic trends. The AI system can use logistical optimization algorithms to plan the most efficient routes and schedules for cash replenishment crews, reducing operational costs and ensuring ATMs are adequately stocked.

In another example, the system can predict environmental impact optimization for ATM distribution. The placement and operation of ATMs have environmental impacts, including energy consumption and contributions to urban heat islands. The AI system can incorporate environmental impact assessments into its decision-making processes for ATM placements, optimizing locations not only for economic and operational efficiency but also for reduced environmental impact. For example, the system can integrate a tool within the AI system that assesses potential environmental impacts of ATM placements, considering factors like energy consumption, heat generation, and accessibility by public transport. The AI system can utilize algorithms that optimize ATM placements not only for operational efficiency but also for minimal environmental impact, encouraging placements in areas with lower energy usage and better access to public transportation.

By integrating these technical solutions into the existing system, the example embodiment can address a broader range of challenges, enhancing its functionality and appeal to financial institutions looking to innovate in the management and operation of their ATM networks.

These explicitly discussed problems and solutions highlight the example embodiment's focus on enhancing time-sensitive data processing, integration flexibility, predictive analytics, data privacy, and decision-making support, thereby addressing significant challenges in the field of ATM placement optimization. By addressing these common challenges, the examples of the present disclosure not only improve the strategic placement of ATMs but also enhance the overall efficiency and effectiveness of financial services, adapting to the evolving needs of the market and the customers.

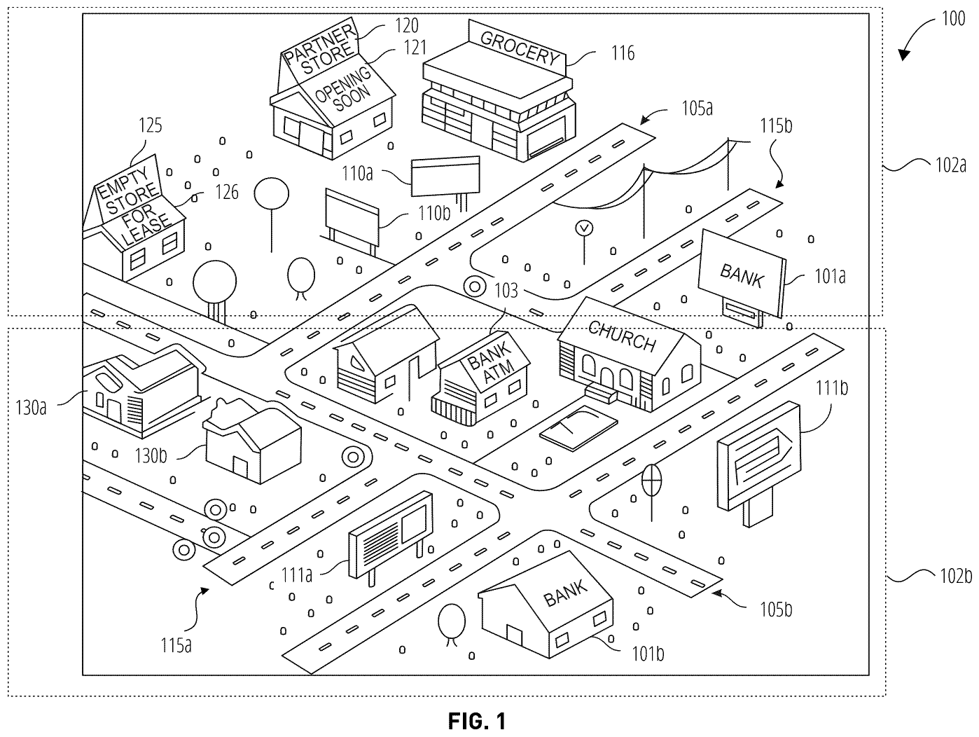

FIG. 1 is a schematic diagram 100 illustrating a map of a town with two zip codes, according to some example embodiments. The schematic diagram 100 shows a first zip code 102a (e.g., 11011) on the top half of the diagram and a second zip code 102b (e.g., 06880) on the bottom half of the diagram.

The schematic diagram 100 illustrates a comprehensive overview of the two-zip-code-town's layout, highlighting the placement of buildings and roads to optimize accessibility and convenience for residents. The diagram 100 features key buildings such as banks 101a-b, a church, a grocery store 116, an empty store 125, a partner store 120, a first empty billboard 110a, a second empty billboard 110b, a first bank billboard 111a, and a second bank billboard 111b, all interconnected by a network of roads including a first main road 105a and a second main road 105b, as well as a first back road 115a and a second back road 115b.

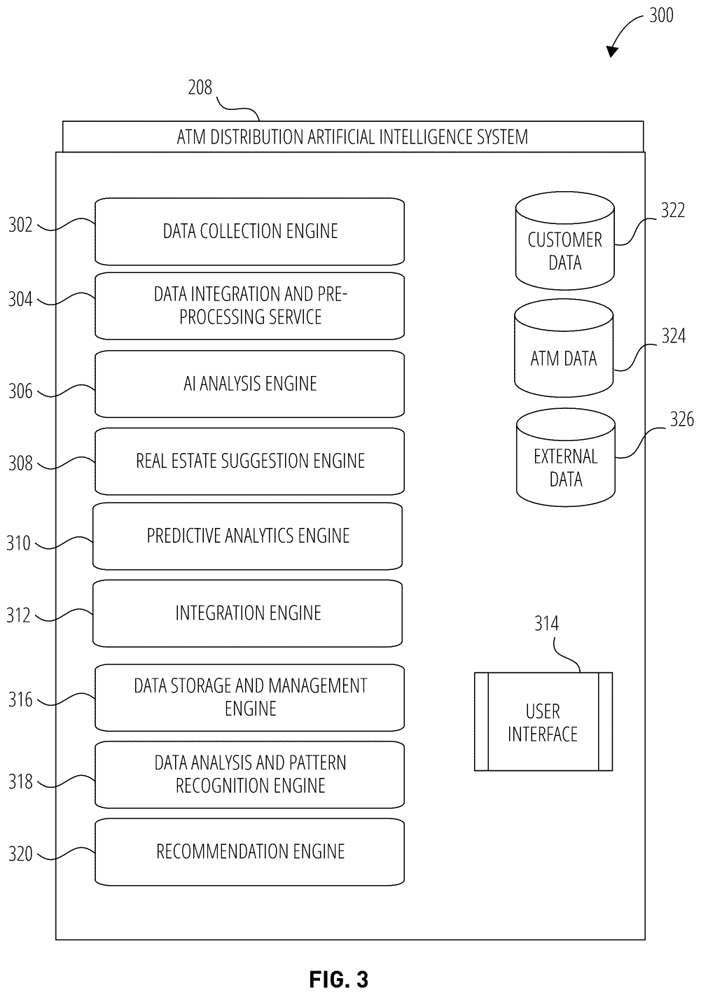

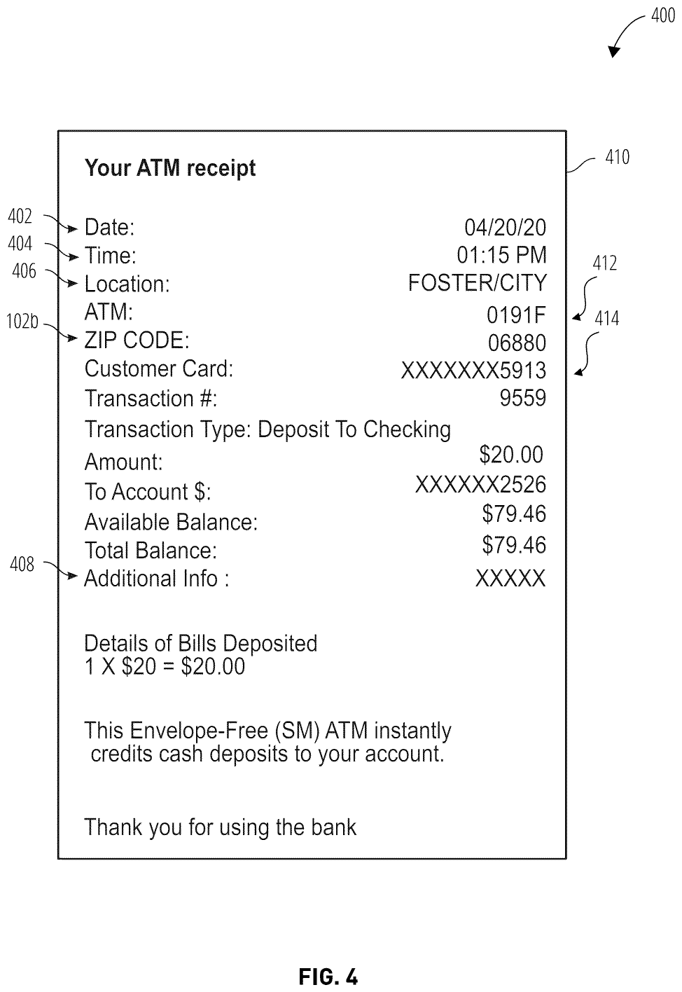

In examples, the ATM distribution artificial intelligence system (described and depicted in connection with FIGS. 3 and 4) prioritizes locations near high-traffic areas such as highway entrances and popular retailers. Examples of the ATM distribution artificial intelligence system are configured to suggest real estate options for new ATM placements, including partner stores and available properties, based on the analysis results. The ATM distribution artificial intelligence system considers zoning laws, construction costs, and other legal and financial constraints in its suggestions. It also prioritizes locations near high-traffic areas such as highway entrances and popular retailers.

In zip code 102a (11011), the small bank branch 101a may only have in-person facilities and no ATMs. Whereas, in zip code 102b (06680), the large bank branch 101b could be a full-service branch offering a range of banking services. Zip code 102b (06880) also includes a bank branch ATM 103, which specifically houses only high-security ATMs. Financial institutions that own these bank locations prefer to strategically place each facility to optimize accessibility for customers. For example, nearby parking facilities (not shown), enhance customer convenience and operational efficiency whereas a bank ATM without good lighting may inconvenience customers. For instance, bank branch ATM 103 is positioned near high-traffic areas such as the entrance of a church parking lot to serve a high volume of users, while large bank branch 101b is located near a less crowded, more secure area to cater to privacy-focused customers from an apartment complex 130a or a single-family house 130b. Alternatives might include ATMs equipped with features like voice guidance for visually impaired users.

The empty store 125 with the “for lease” sign 126 indicates a vacant space available for lease, suggesting potential expansion areas for financial services or other retail activities. For instance, the empty store 125 could be envisioned as a future site for another financial service provider, while the partner store 120 with the “opening soon” sign 121 might be suitable for a retail entity that complements the banking services, such as a financial advisory. The empty store 125 and the partner store 120 are also near an existing grocery store 116, and there are two empty billboards 110a-b. All of these locations are on an intersection of the first main road 105a and the second main road 105b. According to examples of the present disclosure, an ATM distribution artificial intelligence system can dynamically predict this location as a strategic place for a bank branch ATM. Examples of the ATM distribution artificial intelligence system can further suggest marketing the financial institution on the available billboard space, such as the first empty billboard 110a.

Relevant data points can be useful for the ATM distribution artificial intelligence system's ability to predict optimal locations for ATMs, branches, marketing, or the like based on various factors and to be used by various forms of AI as described throughout. For example, relevant data points for the system can include ATM usage data that includes data on how often ATMs are used, the times of day they are most frequently accessed, the types of transactions performed, and the like. This data helps the system identify the demand patterns for ATMs in different locations. In examples, relevant data points for the system can include customer zip code data such as information about where ATM users are coming from, indicated by the zip codes entered during transactions to help the system identify areas with high demand for ATMs but possibly insufficient service.

Additional data points, for example, can include real estate data such as information on available properties for lease or purchase, zoning laws, construction costs, partnering business, or the like to identify feasible and strategic locations for placing new ATMs; demographic and economic data providing predictive analytics that can use data on demographic shifts and economic changes in potential ATM locations to forecast future demand; customer traffic patterns such as data on how customers move around in certain areas, which can influence where ATMs should be strategically placed to maximize accessibility and convenience; social media and mobile data to help identify emerging hotspots for ATM placements, such as areas experiencing sudden increases in popularity or foot traffic; and data from partner stores such as information about partner stores that could host ATMs, based on factors like customer foot traffic and compatibility with the bank's services. Data from public transit systems can indicate commuter patterns and highlight strategic locations near bus stops or train stations for ATM installations. Data on local economic conditions such as employment rates, income levels, and business activity can provide valuable context for determining the viability of new ATM locations. Information on real estate trends, including commercial property prices and rental rates, can inform decisions about where to lease or buy properties for new ATMs. These, and other, relevant data points are integrated and analyzed by the system's AI engine to generate predictive insights, which are then used to make recommendations on where to place ATMs effectively. The system's ability to dynamically incorporate and analyze these data points ensures that the ATM placement recommendations are both data-driven and aligned with current and predicted future needs.

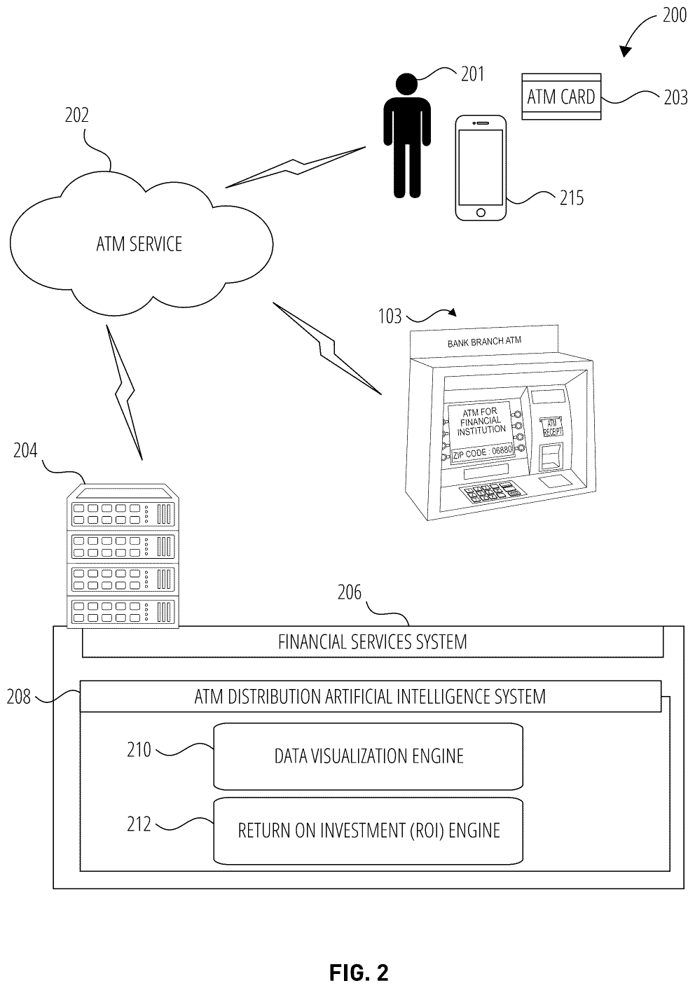

FIG. 2 is a diagram illustrating an ATM communication system 200, according to an embodiment. The ATM communication system 200 provides for communication among an ATM service 202, a mobile device 215, an ATM 103, and a financial services system server 204.

A bank branch customer 201, such as an ATM user, interacts with the ATM service 202 via a mobile device 502 or via the ATM 103. The mobile device 502 can be a client device such as a computing device which may be, but is not limited to, a smartphone, tablet, laptop, multi-processor system, microprocessor-based or programmable consumer electronics, game console, set-top box, or other devices that a user utilizes to communicate over a network. In various examples, a computing device includes a display module (not shown) to display information (e.g., in the form of specially configured user interfaces). In some examples, computing devices may comprise one or more of a touch screen, camera, keyboard, microphone, Global Positioning System (GPS) device, and the like.

The mobile device 215 and/or ATM card 203 and the bank branch ATM 103 can communicate transaction data conducted by the bank branch customer 201 via the ATM service 202. Transaction data can include, in various examples, a location where the bank branch customer 201 used the ATM card 203, a zip code where the bank branch ATM 103 is located, user financial data, user selection data, and/or other data used according to example embodiments. In some examples, the communication may occur using an Application Programming Interface (API) (not shown). Where the API provides a method for computing processes to exchange data.

The financial services system 206 or other system of a financial institution can provide the ATM distribution artificial intelligence system 208, according to various examples. The ATM distribution artificial intelligence system 208 can provide, via a data visualization engine 210, one or more data visualizations for conveying geo-spatial patterns, such as heat maps, choropleth maps, dot density maps, or the like. These visualizations, when used in conjunction with the AI-driven insights from the data analysis, can significantly enhance the decision-making process for ATM placement, ensuring that new ATMs are installed in locations that maximize accessibility and profitability. For examples, heat maps can visually represent areas with high ATM usage and demand intensity. They use color gradations to show how different regions compare in terms of transaction volumes or customer visits. This visualization helps quickly identify hotspots where additional ATMs are needed and areas that are currently overserved. Choropleth maps use various shades of colors to represent different data metrics within predefined geographical areas, such as zip codes or districts. These maps could display metrics like average transaction size, frequency of use, or demographic indicators. These maps can be effective for showing how ATM usage correlates with demographic factors, aiding in making informed decisions about where to target specific customer segments.

The ATM distribution artificial intelligence system 208 tracks a variety of metrics that reflect both the operational efficiency and financial impact of the ATM distribution system via a return on investment (ROI) engine 212. For example, the ROI engine 212 can track ATM transaction volume, cost savings, revenue increase, customer satisfaction and usage rates, foot traffic, ATM uptime and reliability, withdrawal and deposit volumes, cost per transaction, market penetration, and other return on investments. The ROI engine can track the number of transactions processed at each ATM. An increase in transaction volume at newly installed or relocated ATMs can indicate successful optimization. The ROI engine can measure the reduction in operational costs resulting from more strategically placed ATMs. This includes savings from reduced cash transportation needs, lower maintenance costs due to decreased usage at overburdened machines, and potentially lower rent in optimized locations. The ROI engine can monitor the revenue generated from ATM transaction fees. Effective (e.g., optimal) placement should increase the usage of ATMs in high-demand areas, thereby increasing the revenue from transaction fees.

In examples, the ROI engine can use customer surveys and usage data to assess how well the new ATM placements meet customer needs. Higher satisfaction and increased usage rates can indicate successful placements. The system can analyze changes in foot traffic patterns around ATMs. Successful optimization should show increased foot traffic in areas where new ATMs are installed, suggesting that the machines are well-placed to capture more users. The system can track the operational reliability of ATMs. Optimally placed ATMs should have balanced workloads, which can lead to lower downtime and maintenance issues. The system can measure the total value of deposits and withdrawals. This helps in understanding whether the ATMs are adequately serving the financial needs of the surrounding area.

In examples, the ROI engine 212 can calculate the cost associated with each transaction by considering operational expenses divided by the total number of transactions. A lower cost per transaction indicates improved efficiency. The system can assess the bank's market share in areas where ATMs have been optimized. Increased market penetration after optimization efforts can signal effective placement strategies. The system can calculate the ROI by comparing the net benefits (revenue increase and cost savings) to the costs of implementing the optimization system. This metric is crucial for evaluating the financial viability of the investment.

By regularly monitoring these metrics, the financial institution can not only assess the immediate impacts of the ATM optimization system according to the instant disclosure but also make informed decisions for future enhancements and adjustments to the strategy. This data-driven approach ensures that the system continues to meet both customer needs and business objectives effectively.

According to examples, the ATM distribution artificial intelligence system 208 is configured to optimize where ATMs are placed using advanced technology such as implementing edge computing for faster data processing. For example, edge computing enables the system to process information (e.g., data) close to where data is collected (e.g., at ATMs, at branch locations, at partner-locations, etc.). This speeds up the system so it can generate quick decisions about where to place ATMs based on up-to-date information. In such examples, the incorporation of edge computing helps process data closer to the source (e.g., ATMs and user devices), which reduces latency and speeds up data processing. Typically, data processing units process information centrally. However, incorporating edge computing allows data processing closer to the source, significantly reducing latency and improving the speed of decision-making. This is an unconventional use of processing units in a distributed manner to enhance real-time analytic capabilities at the financial institution's network's edges (e.g., ATMs). The system's use of real-time or near real-time data processing is enhanced by edge computing, which combines these technologies to provide faster and more informed decisions, enhancing responsiveness to dynamic market conditions.

The ATM distribution artificial intelligence system 208 is described in more detail in connection with FIG. 3.

FIG. 3 illustrates a block diagram 300 showing a detailed example of the ATM distribution artificial intelligence system 208 illustrated as a set of separate elements (e.g., components, logic, etc.), according to examples. While multiple elements are shown, it will be understood that the functionality of multiple, individual elements can be performed by a single clement or multiple distinct application servers for the financial institution. An element can represent computer program code that is executable by a processing system, for example.

In examples of the present disclosure, the ATM distribution artificial intelligence system 208 is implemented for optimizing ATM placements using advanced artificial intelligence (AI) and predictive analytics. The system 208 comprises several interconnected engines, each performing specific functions to achieve the overall objective of identifying optimal locations for new ATMs. For example, the ATM distribution artificial intelligence system 208 can include a data collection engine 302, a data integration and pre-processing service 304, an AI analysis engine 306, a real estate suggestion engine 308, a predictive analytics engine 310, an integration engine 312, a user interface 314, a data storage and management engine 316, a data analysis and pattern recognition engine 318, and a recommendation engine 320 that can use customer data 322, ATM data 324, and external data 326. In some examples, the ATM distribution artificial intelligence system 208 can include an AI engine, a predictive analytics engine, a time-sensitive (e.g., real-time, near real-time, etc.) data processing engine, a recommendation engine, and a user interface. Each of these components works in tandem to analyze diverse data sources and generate actionable insights for ATM placement decisions.

For example, the data collection engine 302 can collect data from one or more of the customer data 322, the ATM data 324, and the external data 326. The data collection engine 302 is configured to gather data from diverse sources, process the data using advanced AI algorithms, suggest optimal ATM placements, ensure data privacy, and integrate with existing ATM and banking networks. The data collection engine 302 is configured to gather data from diverse sources, including ATM usage data, customer zip code data, and demographic data. The data collection engine 302 can gather data from non-bank ATMs to analyze where customers access their accounts outside the bank's network.

The data integration and pre-processing service 304 can manage and integrate all relevant customer information, such as transaction history, personal identification details, and account settings. This data, as well as other data such as the ATM data 324 and the external data 326, is essential for personalizing customer interactions and for the system to make informed decisions regarding ATM placements and services. The external data 326 storage contains geographical and demographic data used to optimize the placement of ATMs. The ATM distribution artificial intelligence system 208 includes functionalities to anonymize customer data 322, ensuring that personal identifiers are removed or obscured to maintain privacy and comply with regulations.

The AI analysis engine 306 is configured to integrate and analyze data from various sources, including ATM usage data, customer zip code data, and real estate data. The AI analysis engine 306 employs machine learning algorithms such as decision trees, neural networks, and clustering algorithms to identify patterns and trends in the data. Examples of the AI analysis engine 306 can employ continuous learning instead of static operations, the AI analysis engine 306 can be configured to continuously learn and adapt from new data inputs without manual intervention. This can include, for example, using generic processors to perform complex machine learning tasks that dynamically update the models based on real-time data, which is an unconventional approach to maintaining and enhancing predictive accuracy over time.

Examples of the AI analysis engine 306 process the gathered data using advanced AI algorithms (e.g., GenAI, LLMs, etc.) to identify optimal ATM placement locations based on predicted future demand and compliance with legal and financial constraints. The AI analysis engine employs machine learning models such as decision trees or neural networks trained on historical data to predict future ATM usage trends. Examples of the AI analysis engine 306 generate heat maps to visualize areas of high demand for ATM placements. Examples of the AI analysis engine are configured to process the gathered data using advanced AI algorithms to identify optimal ATM placement locations based on predicted future demand and compliance with legal and financial constraints. Examples of the AI analysis engine 306 use machine learning models such as decision trees or neural networks trained on historical data to predict future ATM usage trends. Examples of the AI analysis engine 306 also generate heat maps to visualize areas of high demand for ATM placements.

The real estate suggestion engine 308 can include real estate data, for example, information on available properties for lease or purchase, zoning laws, and construction costs, which are crucial for making informed decisions about ATM placements. Based on the analysis results, the real estate suggestion engine 308 suggests real estate options for new ATM placements, including partner stores and available properties. The real estate suggestion engine 308 considers zoning laws, construction costs, and other legal and financial constraints in its suggestions.

The predictive analytics engine 310 is operatively coupled to one or more additional engines of the ATM distribution artificial intelligence system 208 and is configured to generate predictive insights for optimal ATM placements by considering legal and financial constraints. The predictive analytics engine 310 can forecast future demographic and economic changes in potential ATM locations, providing a forward-looking perspective on ATM placement decisions. The predictive analytics engine 310 can include real-time or near real-time data processing to process incoming data from ATMs and external data sources in real-time or near real-time. Examples of the predictive analytics engine 310 can be operatively coupled to the AI analysis engine 306, and the predictive analytics engine 310 employs advanced algorithms to generate predictive insights for optimal ATM placements, considering various constraints. For example, this can include decision trees, neural networks, and clustering algorithms, these are employed to analyze data and forecast future demographic and economic changes, enhancing the predictive capabilities of the system. The predictive analytics engine 310 can use relevant data points, which can include specific types of data that the system collects and analyzes to make informed decisions (e.g., predictions) about where to place ATMs.

Examples of the integration engine 312 monitors peak usage times and customer wait times at existing ATMs, providing up-to-date information that can influence ATM placement decisions. The integration engine 312 prepares and integrates customer data from various sources into a unified format that is ready for analysis. For example, the integration engine 312 enhances the quality and usability of data within the system. Examples include data integration and management for collecting, synthesizing, and analyzing data from multiple sources into a centralized data structure to maintain data integrity and ensure that all relevant data points (as described and depicted in connection with FIG. 1) are considered in the analysis process. Examples of the integration engine 312 can utilize insights gained from data analysis to develop strategic initiatives for expanding and improving the ATM network. The integration engine 312 focuses on long-term growth and adaptation of the ATM services to changing market conditions. Examples of the integration engine 312 can seamlessly integrate the system with existing ATM and banking networks. Examples of the integration engine 312 employs API-based integration strategies to communicate with existing banking software platforms and supports real-time data updates from existing ATM networks.

Examples of the data storage and management engine 316 can be operably interconnected with a cloud-based data warehouse is utilized for scalable data storage and management. The data storage and management engine 316 can map collected and analyzed data for storing relevant (e.g., useful for AI predictions, training, etc.) data. The data storage and management engine 316 can implement predictive data caching to improve the efficiency of data retrieval and processing and can be configured to predictively cache data that is likely to be needed soon, based on usage patterns and predictive analytics. This is an unconventional use of caching mechanisms, tailored to anticipate future requests and reduce response times in financial operations.

Examples of the data analysis and pattern recognition engine 318 analyzes patterns in customer location data and existing ATM networks to suggest areas that would benefit from new or relocated ATM machines. For example, the data analysis and pattern recognition engine 318 can use of real estate data, including zoning laws and property availability, suggests that the system might integrate Geographic Information Systems (GIS) for spatial analysis. Such data can be relevant for mapping potential ATM locations and understanding geographical constraints and opportunities. Examples of the data analysis and pattern recognition engine 318 can analyze the integrated data to identify patterns and trends that inform strategic decisions, such as where to place new ATMs or which services to offer at specific locations. Unlike traditional systems that might use AI superficially for basic data analysis, examples of the system integrate AI deeply with predictive analytics to not only analyze current data but also to predict future trends and behaviors. This enables the ATM distribution artificial intelligence system 208 to proactively suggest optimal ATM placements based on predicted future changes in demographics and economic conditions, rather than merely reacting to current states.

The recommendation engine 320, also operatively coupled to one or more engines of the ATM distribution artificial intelligence system 208, is configured to suggest optimal ATM locations based on the predictive insights generated. The recommendation engine 320 can also suggest (e.g., predict, recommend) partner stores for ATM placements or distribution based on customer traffic patterns and recommend the removal of underperforming or sub-optimal ATMs. The recommendation engine 320 suggests optimal ATM locations based on predictive insights generated by the analytics engine. The recommendation engine 320 can predict multiple optimal distribution points for ATMs, where each distribution point or location of real estate to select for use by a financial institution to implement an ATM can have one or more different strengths and/or weaknesses that identify the distribution location as optimal. It also provides options for adjusting recommendations based on real-time and qualitative data, enhancing decision-making flexibility. The recommendation engine 320 can provide, via the user interface 314, one or more data visualizations for conveying geo-spatial patterns, such as heat maps, choropleth maps, dot density maps, or the like.

Examples of the user interface 314 are operatively connected to the recommendation engine 320 and are configured to display the suggested ATM locations to bank operators for decision-making. The user interface 314 allows bank operators to adjust the suggested ATM locations based on qualitative data, ensuring that the final decisions are well-rounded and consider all relevant factors. The user interface of the ATM distribution artificial intelligence system 208 is designed to display suggested ATM locations to bank operators effectively. It allows operators to adjust the suggested locations based on qualitative data, thereby enhancing the decision-making process, and ensuring that final placement decisions are well-rounded and consider all relevant factors. The user interface 314 is a UI for agents of the financial institution. In examples of the user interface 314, rather than merely displaying information, the UI can be configured to interactively guide bank operators through decision-making processes, suggesting adjustments based on real-time data and predictive analytics. This involves using display components and interface software in a way that actively engages users in a decision support system, enhancing their ability to make informed choices quickly. Examples of the system also focuses on the user interface (UI) design, which is tailored to display ATM placement suggestions to bank operators effectively. The UI allows operators to interact with the system, make informed decisions based on the data presented, and adjust recommendations based on qualitative insights. This component emphasizes the importance of human-computer interaction in making strategic decisions based on AI-generated insights.

Alternative configurations may include additional or fewer data processing engines or different types of storage units. In summary, the diagram provides a comprehensive overview of the components and data flow within an ATM service system, highlighting the interaction between users, ATM machines, and the cloud-based processing and storage infrastructure.

Examples of the ATM distribution artificial intelligence system 208 also include a method for optimizing ATM placements, which involves collecting data from various sources, integrating the collected data into a centralized data structure, analyzing the integrated data using advanced AI algorithms, generating a list of suggested ATM locations, and displaying the suggested ATM locations to bank operators for decision-making. The method further includes forecasting future demographic and economic changes, suggesting partner stores for ATM placements, anonymizing customer data to ensure compliance with data privacy regulations, scoring potential ATM locations using multi-criteria decision analysis (MCDA), monitoring peak usage times and customer wait times, suggesting the removal of underperforming ATMs, and integrating social media and mobile data to identify emerging hotspots for ATM placements. This data can help identify emerging trends and customer needs that are not captured through traditional data sources.

Additionally, examples include a machine-readable medium storing instructions that, when executed by a processor, cause the processor to perform the method for optimizing ATM placements. The instructions include collecting data, integrating the data into a centralized data structure, analyzing the data using advanced AI algorithms, generating a list of suggested ATM locations, and displaying the suggested ATM locations to bank operators for decision-making. The machine-readable medium can include instructions for forecasting future demographic and economic changes, suggesting partner stores for ATM placements, anonymizing customer data, scoring potential ATM locations using MCDA, monitoring peak usage times and customer wait times, suggesting the removal of underperforming ATMs, and integrating social media and mobile data to identify emerging hotspots for ATM placements.

Examples of the AI system can utilize a complex algorithm(s) that incorporates geographic information systems (GIS) data to analyze potential ATM locations. The GIS data can include layers for zoning restrictions, which would automatically filter out locations where financial services are not permitted. Examples of the AI system can use econometric models to estimate potential construction costs based on regional economic data, such as the cost of labor and materials in different zip codes. For example, the AI system can employ a multi-criteria decision analysis (MCDA) approach, where each potential site is scored based on various factors such as customer density, proximity to high-traffic areas, legal feasibility, and estimated setup costs. The AI system can use a decision tree or a neural network trained on historical data to predict the success of new ATM locations, taking into account both past performances of similar decisions and current market conditions.

Examples of the AI system can simulate various scenarios using predictive analytics to forecast future changes in the area, such as demographic shifts or economic developments, which could impact the viability of the ATM over time. This predictive capability allows the system to not only assess current suitability but also to anticipate future trends that could affect the ATM's usage and profitability. The AI system begins by collecting data from various sources. This includes ATM usage data, which tracks where and when customers are accessing ATMs, as well as zip code data from these transactions. Additional data can include, for example, demographic information and economic indicators of specific areas, gathered from public databases or purchased from data vendors. Once data is collected, it is integrated into a centralized data structure, possibly a cloud-based data warehouse. Data from different sources is standardized and stored in a format suitable for analysis to ensure that all relevant data points are combined to form a comprehensive view of ATM usage patterns and customer behaviors. With the data integrated, the AI system can apply machine learning algorithms to analyze patterns and predict optimal new ATM locations. For example, this can involve clustering algorithms to identify areas with high potential for ATM usage but low current coverage.

In examples, predictive models can also forecast future changes in demographics or economic conditions that might influence ATM usage. Based on the analysis, the AI system can generate a list of suggested locations for new ATMs. These suggestions are ranked based on various factors such as predicted customer usage, proximity to partner stores (e.g., as potential ATM hosts), and compliance with zoning laws. Each suggested location can be associated with a score that reflects its expected effectiveness in improving service and accessibility. In some examples, the suggested locations are then reviewed by human analysts who can adjust the recommendations based on additional qualitative data not captured by the AI, such as planned urban development projects or upcoming changes in local regulations to ensure that the AI system's recommendations are aligned with the financial institution's (e.g., banks) strategic goals and local market conditions. Once locations are finalized, the implementation phase begins. This can include logistical planning for the installation of ATMs, negotiations with property owners (if ATMs are to be placed in partner stores or other commercial properties) and obtaining necessary permits and approvals.

In examples, the ATM distribution artificial intelligence system 208 is designed with a modular architecture, enhancing flexibility and ease of updates. The ATM distribution artificial intelligence system 208 can be implemented using a modular architecture, which facilitates casier updates and scalability. In such examples, it employs API gateways and microservices architecture to ensure effective communication with different components of the banking network, allowing for smoother integration and better management of services. The use of API gateways and microservices further supports this by enabling smoother communication between disparate systems, reducing integration issues, and allowing for scalable updates and enhancements.

FIG. 4 is a diagram 400 illustrating a customer ATM receipt 410 from an ATM, according to some example embodiments.

The ATM receipt 410 includes various elements such as date 402, time 404, location 406, ATM identifier 412, and additional information 408. The date 402 and time 404 indicate when the transaction occurred. The location 406 specifies the physical location of the ATM where the transaction took place, such as at a specific zip code 102b (e.g., zip code 06880). The customer card 414 represents the card used by the customer to perform the transaction. Additional information 408 may include other relevant transaction details such as transaction ID, balance information, promotional messages, or the like. The detailed labeling in the ATM receipt 410 helps in identifying, analyzing, and predicting various aspects of ATM transactions, which can be crucial for data collection and analysis engines as described in the claims.

The zip code 102b represents a specific input field within the ATM interface where users can enter their ZIP code, or the ATM can read their zip code based on their ATM card, the ATM location, the user's mobile device, or the like. This data is used by the ATM distribution artificial intelligence system 208 to analyze the geographical distribution of users and optimize the placement of future ATMs. For instance, if a significant number of transactions are recorded from non-local ZIP codes, it might suggest a demand for ATMs in those areas.

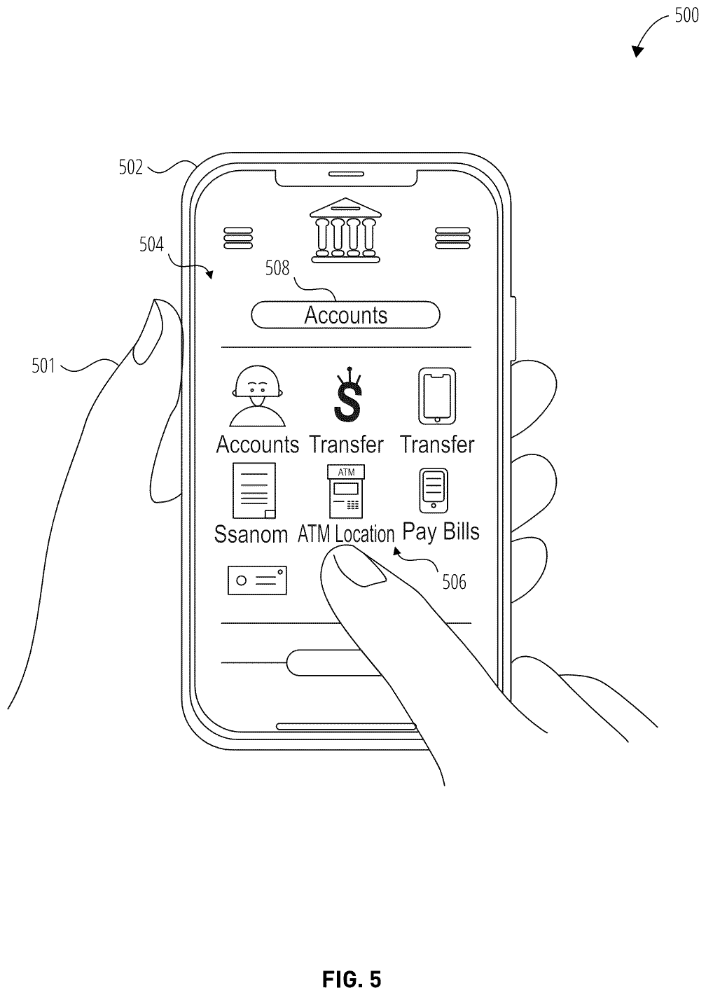

FIG. 5 illustrates a block diagram 500 showing an example user interface on a mobile device, according to some example embodiments.

A client device includes a mobile device 502. Other client devices are included in the scope of this discussion including, but not limited to kiosks, in-vehicle infotainment systems, desktops, smartphones, tablets, and the like. The bank branch customers 201 may use the mobile device 502 to set preferences to configure the user interface (UI) of the ATM 103. The bank branch customer 201 may use the mobile device 502 while mobile or use the laptop device (not shown) while at home, for example.

The mobile device 502 may be connected to an ATM service 202, which may be hosted in a cloud service or cloud computing system. The ATM service 202 may communicate with the ATM 103 and provide the UI settings for the bank branch ATM 103. Different settings may be used based on the ATM's location, type, or other characteristic of the ATM. In this way, the bank branch customer 201 may personalize the UI with more granularity.

The user interface 504 provides an ATM location icon 506 that a user can interact with. For example, the user 501 can locate ATM locations in examples. In examples of the ATM location icon 506, the user can also identify locations on a map or by entering a zip code or street address of where the user would like to see an ATM. This data can be collected by the ATM distribution artificial intelligence system 208 and be used in identifying locations for ATM distribution.

A non-ATM channel includes any platform that is not the ATM kiosk. Examples of non-ATM channels include a home computer, mobile phone, or an in-vehicle infotainment system. Embodiments described in this document provide an interface to a customer on a non-ATM channel that allows the customer to customize and personalize the ATM experience. The customer 201 may perform any of three main types of customizations: 1) modify the ATM UI, 2) test transactional flow using an ATM simulator, and 3) create a pre-staged transaction.

User accounts 508 can include user profiles on users of application server (not shown). A user profile can include credential information such as a username and hash of a password. A user can enter in their username and plaintext password to a login page of application server to view their user profile information or interfaces presented by application server in various examples. Different types of users can have different interfaces presented. A user account 508 can also include preferences of the user. The preferences can include default preferences on if a financial status indicator should be displayed according to different time periods, can be displayed at various levels (e.g., always display the financial status indicator at $20 more than net-zero) etc. The financial institution can operate application server.

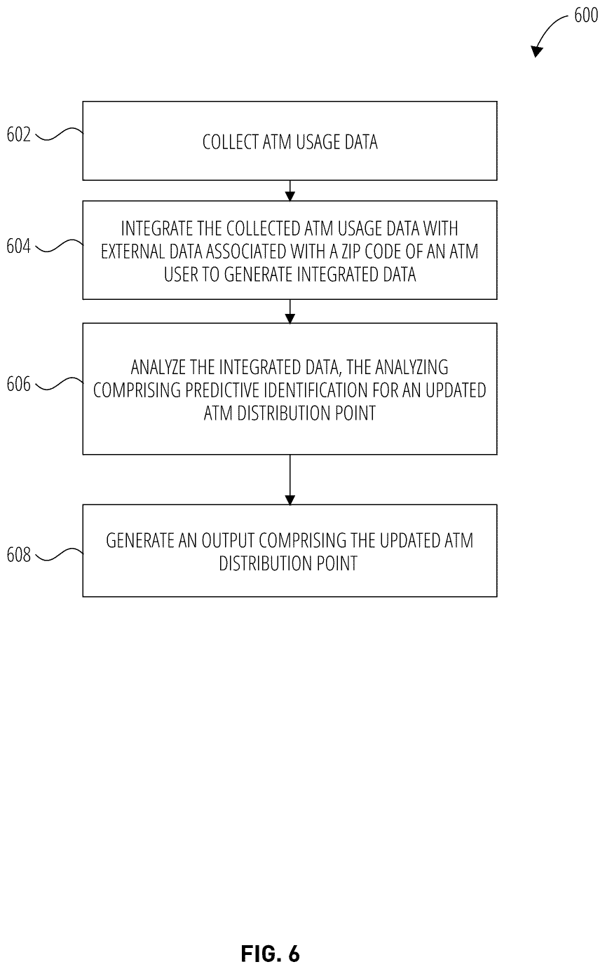

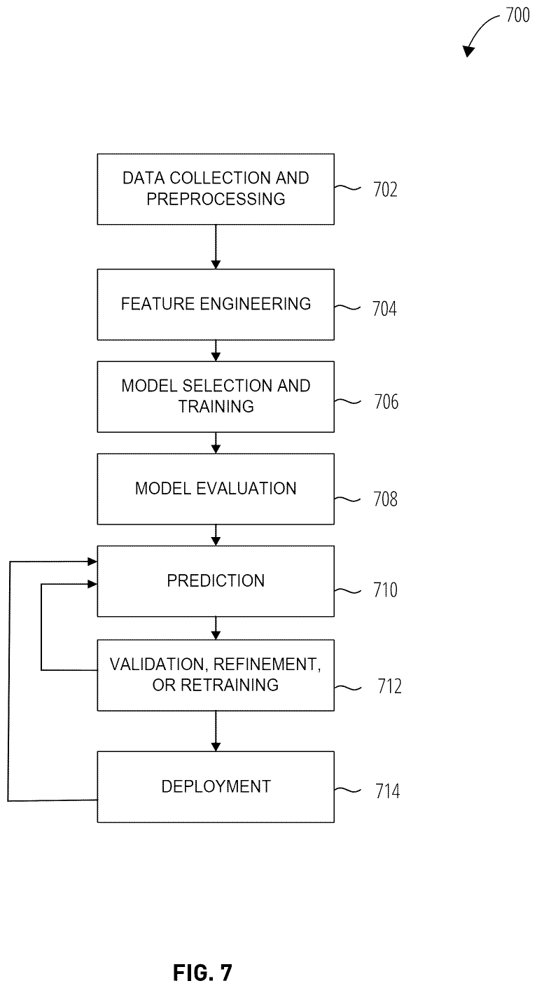

FIG. 6 illustrates a flow diagram of a method 600 for selecting a location for automated teller machine (ATM) distribution point placement, according to some example embodiments. The method 600 can be embodied in machine-readable instructions for execution by one or more hardware components (e.g., one or more processors, one or more hardware processors) such that the operations of the method 600 can be performed by components of the systems depicted in FIG. 2, FIG. 3, and/or FIGS. 7-9, such as the ATM distribution artificial intelligence system 208. Accordingly, the method 600 is described below, by way of example with reference to components of the ATM distribution artificial intelligence system 208. However, it shall be appreciated that method 600 can be deployed on various other hardware configurations and is not intended to be limited to deployment within the hardware of examples presented herein.

Depending on the example embodiment, an operation of the method 600 can be repeated in different ways or involve intervening operations not shown. Though the operations of the method 600 can be depicted and described in a certain order, the order in which the operations are performed may vary among embodiments, including performing certain operations in parallel or performing sets of operations in separate processes. While the various operations in this flowchart are presented and described sequentially, one of ordinary skill will appreciate that some or all of the operations may be executed in a different order, be combined or omitted, or be executed in parallel.

In operation 602, the ATM distribution artificial intelligence system 208, collects ATM usage data. In operation 604, the ATM distribution artificial intelligence system 208, integrates the collected ATM usage data with external data associated with a zip code of an ATM user to generate integrated data. In operation 606, the ATM distribution artificial intelligence system 208, analyzes the integrated data, the analyzing comprising predictive identification for an updated ATM distribution point. In operation 608, the ATM distribution artificial intelligence system 208 generates an output comprising the updated ATM distribution point.

For example, the method 600 can include implementation of an AI engine or utilization of generative AI to predict ATM distribution point placement (e.g., the physical location for an ATM). For example, a bank utilizes an advanced AI model within their ATM placement system. The AI model is configured to integrate diverse data sources such as ATM usage logs, customer zip codes from transaction data, real estate listings, external data, or the like. By employing neural networks, the AI model analyzes patterns in ATM usage and identifies arcas with high transaction volumes but insufficient ATM coverage. This analysis helps the bank to strategically plan new ATM installations in underserved areas. The AI system (e.g., one or more AI models) used by the present system can receive data from external data sources, such as sources external to the financial institution associated with the ATM. For example, external data sources can include the Internet, external services, data scraping from external resources to retrieve data such as driving traffic patterns, foot traffic patterns, real estate availabilities (e.g., purchases, sales, vacancies, etc.) for residential and commercial properties, construction zones, location (e.g., town, city, etc.) zoning laws and changes, and the like. In examples, the AI system including one or more machine learning models includes defining one or more data source rules associated with the internal data and/or the external data associated with the financial institution, the customer, the ATM user, and/or the ATM distribution point as one or more features for the model(s) and training an ATM distribution point selection model using the defined one or more features. Then, a search index is used during the model training process to calculate both the precision and the recall of the one or more potential distribution points to include in the AI generated output providing predictive analysis for placement of ATMs and/or marketing associating with the placement of ATMs.

As described in more detail below in connection with FIGS. 7-9, feature engineering can include a phase for selecting and transforming the training data to create features (e.g., internal data, external data, financial institution data, customer data, etc.) that are useful for predicting the target variable (e.g., ATM distribution point locations). Feature engineering may include (1) receiving features (e.g., as structured or labeled data in supervised learning) and/or (2) identifying features (e.g., unstructured, or unlabeled data for unsupervised learning) in training data. Model selection and training can include a phase for selecting an appropriate machine learning algorithm or model and training it on the preprocessed data. This phase may further involve splitting the data into training and testing sets, using cross-validation to evaluate the model, and tuning hyperparameters to improve performance. A financial institution associated with one or more ATMs in a town with two zip codes, such as depicted and described in connection with FIG. 1, can use features (e.g., structured and/or unstructured data) received internally from the financial institution or externally from scraping external services or Internet sources for data that can train the ATM distribution point model. For example, the financial institution can train the model using residential and commercial real estate information, government zoning laws and restrictions, and traffic patterns in the two-zip code town.

The AI system described for optimizing ATM placement leverages a variety of data sources to train its predictive models effectively. These sources, for example, can include both internal and external data, each playing a crucial role in understanding patterns and making informed decisions about where to place ATMs. Data sources and acquisition can be from internal data and external data. Examples, but not limitations, of internal data can include ATM usage logs, which record transaction volumes, frequencies, and times at each machine. Additionally, customer zip codes from transaction data provide insights into where users are coming from, which helps in identifying areas with high demand but low ATM coverage. This data can be directly collected from the bank's transactional systems. External data, for example and not limitation, is used to integrate data from various external sources. For example, real estate listings including information about available properties for sale or rent can indicate potential high-traffic areas suitable for new ATMs. Traffic patterns including data regarding both driving and foot traffic, which can be sourced from local government transport departments or private traffic analytics services, helps in identifying areas with high pedestrian or vehicular flow. Zoning laws and possible legislation including information on zoning laws obtained from municipal or city council websites can affect where ATMs can legally be placed. Construction zones including ongoing construction activities, which can be sourced from local construction and planning departments, might indicate future developments and potential new markets for ATM placements. These external data sources are often accessed via APIs, web scraping, or direct partnerships with data providers, ensuring a continuous stream of up-to-date information.

Once the data is collected, it undergoes a transformation process to convert it into a format that the AI models can understand. This can include, by example and not limitation, data cleaning including removing inaccuracies and filling in missing values, data integration including combining data from multiple sources into a unified format, feature engineering including transforming raw data into features that effectively represent the underlying patterns relevant to ATM placements. For example, converting raw traffic counts into peak and off-peak averages, or categorizing zip codes based on transaction volumes.

The training data must be labeled for supervised learning, which involves defining what each data point represents and what output it should predict. For ATM placement, labeling including each potential ATM location (data point) might be labeled with a score representing its suitability based on past data about customer density, existing ATM coverage, and other socio-economic factors. The AI models, such as neural networks or decision trees, are then trained on this labeled data. The training can include for example and not limitation, model selection including choosing the right machine learning model that fits the type of data and the prediction task. Cross-validation including using part of the data to train the model and another part to test it, ensuring the model generalizes well to new, unseen data. Hyperparameter tuning including adjusting parameters of the model to optimize performance. Through these processes, the AI system learns to identify patterns and correlations between features and the successful placement of ATMs, enabling it to predict new locations with high potential for ATM installations effectively. This predictive capability by the one or more machine learning models or AI models is continually refined as new data is collected and fed back into the system, creating a dynamic, learning AI tool that adapts to changing urban landscapes and consumer behaviors.

According to examples, additional external data sources for ATM placement optimization can include a variety of sources. For example, to further enrich the ATM placement optimization models, additional external data sources could include social media data including analyzing trends and check-ins on media platforms to gauge popular areas and events which might benefit from ATM placements; Economic indicators including data on local economic activity such as business openings, employment rates, and income levels which can influence ATM usage patterns; Retail and commercial business data including information on the presence and performance of nearby businesses which can attract foot traffic; Public transportation data including schedules, station locations, and usage statistics of public transport networks to identify high-commuter areas lacking ATM services; Tourist and seasonal data including information on tourist flows and seasonal population increases which could affect temporary ATM needs; Crime statistics including safety is a crucial factor in ATM placement, and integrating crime data can help in selecting safer locations.

In examples, for predicting optimal ATM locations, several alternative machine and deep learning algorithms could be considered including: Random Forests: An ensemble learning method for classification and regression that could handle the non-linear relationships and interactions between features effectively; Gradient Boosting Machines (GBM): A powerful ensemble technique that builds models sequentially to minimize errors and can be very effective in predictive accuracy; Support Vector Machines (SVM): Useful for classification tasks, SVM could help in distinguishing between potentially successful and unsuccessful ATM locations; K-Means Clustering: To identify naturally occurring clusters in data, which can suggest potential hotspots for ATM installations.

Examples of the ATM placement optimization system involves a comprehensive workflow that integrates various data sources and employs advanced machine learning techniques to predict optimal ATM locations. For example, components and workflow of the AI system can include: Data Ingestion including collecting data from both internal sources (like ATM transaction logs and customer demographics) and external sources (such as real estate listings, traffic patterns, and economic indicators); Data Preparation including cleaning, integrating, and transforming raw data into a structured format suitable for analysis. This portion also involves feature engineering to create meaningful attributes that influence ATM placement decisions; Model Training including selecting appropriate machine learning algorithms and training them on the prepared dataset. This process includes splitting the data into training and testing sets, performing cross-validation, and tuning model parameters to optimize performance. Further components and workflow of the AI system can include: Prediction and Recommendations including using the trained models to predict new, optimal locations for ATM installations based on the learned patterns and insights. The system generates recommendations which are then reviewed and potentially implemented by decision-makers. Examples of the AI system leverages a blend of data-driven insights and advanced analytics to strategically enhance the distribution of ATMs using near real-time, real-time, or otherwise scheduled data by a machine learning model aiming to maximize accessibility and profitability while adapting to dynamic market conditions.

For example, the method 600 can include implementation of predictive analytics for future demographics using one or more AI models to simulate possible future scenarios associated with metrics related to an ATM distribution point. The predictive analytics engine of the system forecasts demographic changes in a suburban area experiencing rapid residential development. By analyzing historical data and current trends, the engine predicts an increase in the local population and suggests new ATM locations in upcoming residential complexes and shopping centers, ensuring that future demand is met.

For example, the method 600 can include implementation of real-time or near real-time data processing and peak usage monitoring. The system's real-time data processing unit continuously receives and processes data from ATMs across the city. It monitors peak usage times and customer wait times, particularly in densely populated business districts. The system identifies several ATMs that consistently experience high traffic and long wait times during lunch hours on weekdays, suggesting either the addition of machines or the relocation of existing ones to adjacent, less congested areas.

For example, the method 600 can include utilizing customer traffic pattern data, the recommendation engine suggests placing ATMs in high-traffic partner stores such as grocery stores and shopping malls. For instance, the system identifies a popular grocery store without an ATM but with significant foot traffic and recommends it as an ideal location for a new ATM to increase accessibility and convenience for shoppers.

For example, the method 600 can include implementation of the system's user interface display of a map-based view of suggested ATM locations to bank operators. The UI enables financial institution operators to see the rationale behind each prediction (e.g., suggestion for ATM distribution), such as proximity to high-traffic areas, availability of real estate, and compliance with zoning laws. Operators can manually adjust the suggestions by adding qualitative data like upcoming local developments or community feedback, refining the system's recommendations.

For example, the method 600 can include implementation of enhanced privacy to comply with data privacy regulations, the AI engine anonymizes personal identifiers in customer data before processing. This ensures that all analyses on customer behavior and preferences are conducted without exposing sensitive information, maintaining customer trust and regulatory compliance.

For example, the method 600 can include implementation of multi-criteria decision analysis for location scoring to predict optimal ATM distribution points. The predictive analytics engine employs MCDA to evaluate potential ATM locations. Each location is scored based on multiple criteria, including customer density, transaction frequency, security considerations, and operational costs. This comprehensive scoring system helps the bank prioritize locations that offer the best balance of benefits and risks.

For example, the method 600 can include implementation of an AI engine to integrate data from social media and mobile apps to identify emerging hotspots for ATM placements. For example, a sudden spike in social media check-ins and mobile location data at a new entertainment district prompts the system to recommend placing ATMs in that area to serve the increasing foot traffic. These examples provide practical illustrations of how the claimed features and functions can be implemented in a real-world banking environment, demonstrating the utility and innovative aspects of the system and method for optimizing ATM placements.

Described implementations of the subject matter can include one or more features, alone or in combination as illustrated below by way of example.

Example 1 is a system for selecting a location for automated teller machine (ATM) placement using one or more artificial intelligence (AI) models, the system comprising: one or more hardware processors of a machine; and at least one memory storing instructions that, when executed by the one or more hardware processors, cause the system to perform operations comprising: collecting ATM usage data; integrating the collected ATM usage data with external data associated with a zip code of an ATM user to generate integrated data for use by the one or more AI models, the external data received from outside a financial institution associated with an ATM; analyzing, by the one or more machine learning models, the integrated data, the analyzing comprising predictive identification for an updated ATM distribution point by the one or more AI models; and generating an output comprising the updated ATM distribution point.

In Example 2, the subject matter of Example 1 includes, wherein collecting the ATM usage data further comprises: collecting the external data from a plurality of external data sources comprising at least one of demographic data, real estate availability data, foot traffic pattern data, economic indicator data, or a partner store location.

In Example 3, the subject matter of Examples 1-2 includes, the operations further comprising: identifying customer ATM traffic patterns associated with existing ATM distribution points; identifying a potential partner store location; associating the customer ATM traffic patterns with the potential partner store location; and recommending, based on the associating, the potential partner store location for placement of the updated ATM distribution point based on the customer ATM traffic patterns.

In Example 4, the subject matter of Examples 1-3 includes, the operations further comprising: employing predictive analytics to forecast demographic and economic changes affecting a potential ATM distribution point among a plurality of existing ATM distribution points; and combining the predictive analytics and the integrated data to identify an optimal ATM distribution point based on the forecasted demographic and economic changes.

In Example 5, the subject matter of Example 4 includes, the operations further comprising: scoring the potential ATM distribution point, the scoring comprising utilizing multi-criteria decision analysis to predict the optimal ATM distribution point.

In Example 6, the subject matter of Example 5 includes, the operations further comprising: monitoring the plurality of existing ATM distribution points to identify peak usage times; associating the peak usage times with customer wait times; and adjusting the scoring of the potential ATM distribution point based on the associating.

In Example 7, the subject matter of Examples 1-6 includes, wherein the generating the output comprising the updated ATM distribution point further comprises: employing an econometric model to estimate potential construction costs based on regional economic data associated with the updated ATM distribution point.

In Example 8, the subject matter of Examples 1-7 includes, the operations further comprising: providing a user interface to enable an operator of the financial institution to adjust the updated ATM distribution point based on qualitative data received by the financial institution.

In Example 9, the subject matter of Examples 1-8 includes, wherein generating the output further comprises: monitoring a plurality of metrics associated with the ATM usage data in near real-time; and generating a data visualization for conveying a plurality of geo-spatial patterns associated with the updated ATM distribution point based on at least one of the plurality of metrics.

In Example 10, the subject matter of Examples 1-9 includes, the operations further comprising: identifying an underperforming existing ATM distribution point; and recommending removal of the underperforming existing ATM distribution point.

Example 11 is a computer-implemented method for selecting a location for automated teller machine (ATM) placement using one or more artificial intelligence (AI) models, the method comprising: collecting, by at least one hardware processor, ATM usage data; integrating the collected ATM usage data with external data associated with a zip code of an ATM user to generate integrated data for use by the one or more AI models, the external data received from outside a financial institution associated with an ATM; analyzing, by the one or more AI models, the integrated data, the analyzing comprising predictive identification for an updated ATM distribution point by the one or more AI models; and generating an output comprising the updated ATM distribution point.

In Example 12, the subject matter of Example 11 includes, wherein collecting the ATM usage data further comprises: collecting the external data from a plurality of external data sources comprising at least one of demographic data, real estate availability data, foot traffic pattern data, economic indicator data, or a partner store location.

In Example 13, the subject matter of Examples 11-12 includes, identifying customer ATM traffic patterns associated with existing ATM distribution points; identifying a potential partner store location; associating the customer ATM traffic patterns with the potential partner store location; and recommending, based on the associating, the potential partner store location for placement of the updated ATM distribution point based on the customer ATM traffic patterns.

In Example 14, the subject matter of Examples 11-13 includes, employing predictive analytics to forecast demographic and economic changes affecting a potential ATM distribution point among a plurality of existing ATM distribution points; and combining the predictive analytics and the integrated data to identify an optimal ATM distribution point based on the forecasted demographic and economic changes.

In Example 15, the subject matter of Example 14 includes, scoring the potential ATM distribution point, the scoring comprising utilizing multi-criteria decision analysis to predict the optimal ATM distribution point.

In Example 16, the subject matter of Example 15 includes, monitoring the plurality of existing ATM distribution points to identify peak usage times; associating the peak usage times with customer wait times; and adjusting the scoring of the potential ATM distribution point based on the associating.

In Example 17, the subject matter of Examples 11-16 includes, wherein the generating the output comprising the updated ATM distribution point further comprises: employing an econometric model to estimate potential construction costs based on regional economic data associated with the updated ATM distribution point.

In Example 18, the subject matter of Examples 11-17 includes, providing a user interface to enable an operator of the financial institution to adjust the updated ATM distribution point based on qualitative data received by the financial institution.

In Example 19, the subject matter of Examples 11-18 includes, wherein generating the output further comprises: monitoring a plurality of metrics associated with the ATM usage data in near real-time; and generating a data visualization for conveying a plurality of geo-spatial patterns associated with the updated ATM distribution point based on at least one of the plurality of metrics.

In Example 20, the subject matter of Examples 11-19 includes, identifying an underperforming existing ATM distribution point; and recommending removal of the underperforming existing ATM distribution point.

Example 21 is a machine-storage medium comprising instructions, which when executed by one or more artificial intelligence (AI) models on a computer, cause the one or more AI models to perform operations for selecting a location for automated teller machine (ATM) placement, the operations comprising: collecting ATM usage data; integrating the collected ATM usage data with external data associated with a zip code of an ATM user to generate integrated data for use by the one or more AI models, the external data received from outside a financial institution associated with the ATM; analyzing, by the one or more AI models, the integrated data, the analyzing comprising predictive identification for an updated ATM distribution point by the one or more AI models; and generating an output comprising the updated ATM distribution point.

Example 22 is at least one machine-readable medium including instructions that, when executed by processing circuitry, cause the processing circuitry to perform operations to implement of any of Examples 1-21.

Example 23 is an apparatus comprising means to implement of any of Examples 1-21.

Example 24 is a system to implement of any of Examples 1-21.

Example 25 is a method to implement of any of Examples 1-21.

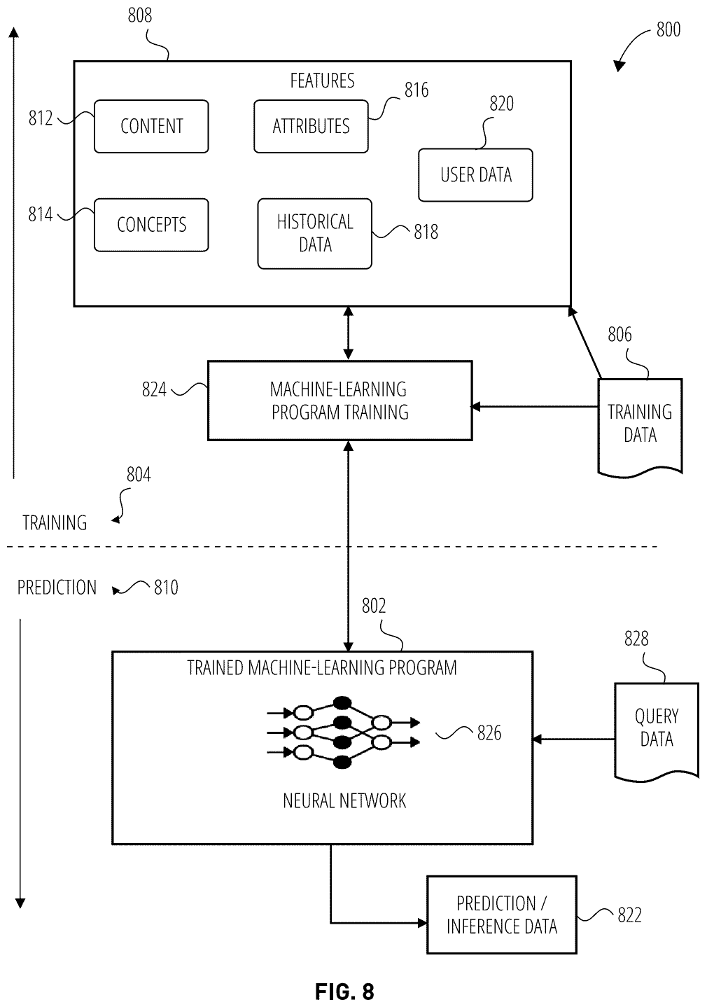

FIG. 7 depicts a machine-learning pipeline 700 and FIG. 8 illustrates training and use of a machine-learning program (e.g., model) 800. Specifically, FIG. 7 is a flowchart depicting a machine-learning pipeline 700, according to some examples. The machine-learning pipeline 700 can be used to generate a trained model, for example the trained machine-learning program 802 of FIG. 8, to perform operations associated with searches and query responses.

Broadly, machine learning may involve using computer algorithms to automatically learn patterns and relationships in data, potentially without the need for explicit programming. Machine learning algorithms can be divided into three main categories: supervised learning, unsupervised learning, self-supervised, and reinforcement learning.

For example, supervised learning involves training a model using labeled data to predict an output for new, unseen inputs. Examples of supervised learning algorithms include linear regression, decision trees, and neural networks. Unsupervised learning involves training a model on unlabeled data to find hidden patterns and relationships in the data. Examples of unsupervised learning algorithms include clustering, principal component analysis, and generative models like autoencoders. Reinforcement learning involves training a model to make decisions in a dynamic environment by receiving feedback in the form of rewards or penalties. Examples of reinforcement learning algorithms include Q-learning and policy gradient methods.

Examples of specific machine learning algorithms (e.g., ML models, AI models, LLMs, etc.) that may be deployed, according to some examples, include logistic regression, which is a type of supervised learning algorithm used for binary classification tasks. Logistic regression models the probability of a binary response variable based on one or more predictor variables. Another example type of machine learning algorithm is Naïve Bayes, which is another supervised learning algorithm used for classification tasks. Naïve Bayes is based on Bayes' theorem and assumes that the predictor variables are independent of each other. Random Forest is another type of supervised learning algorithm used for classification, regression, and other tasks. Random Forest builds a collection of decision trees and combines their outputs to make predictions.

Further examples include neural networks, which consist of interconnected layers of nodes (or neurons) that process information and make predictions based on the input data. Matrix factorization is another type of machine learning algorithm used for recommender systems and other tasks. Matrix factorization decomposes a matrix into two or more matrices to uncover hidden patterns or relationships in the data. Support Vector Machines (SVM) are a type of supervised learning algorithm used for classification, regression, and other tasks. SVM finds a hyperplane that separates the different classes in the data. Other types of machine learning algorithms include decision trees, k-nearest neighbors, clustering algorithms, and deep learning algorithms such as convolutional neural networks (CNN), recurrent neural networks (RNN), and transformer models. The choice of algorithm depends on the nature of the data, the complexity of the problem, and the performance requirements of the application.

The performance of machine learning models is typically evaluated on a separate test set of data that was not used during training to ensure that the model can generalize to new, unseen data.

Although several specific examples of machine learning algorithms are discussed herein, the principles discussed herein can be applied to other machine learning algorithms as well. Deep learning algorithms such as convolutional neural networks, recurrent neural networks, and transformers, as well as more traditional machine learning algorithms like decision trees, random forests, and gradient boosting may be used in various machine learning applications.

Two example types of problems in machine learning are classification problems and regression problems. Classification problems, also referred to as categorization problems, aim at classifying items into one of several category values (e.g., is this object an apple or an orange?). Regression algorithms aim at quantifying some items (for example, by providing a value that is a real number).

Turning to the training phases 804 as described and depicted in connection with FIG. 8, generating a trained machine-learning program 802 may include multiple phases that form part of the machine-learning pipeline 700, including, for example, the following phases illustrated in FIG. 7: data collection and preprocessing 702, feature engineering 704, model selection and training 706, model evaluation 708, prediction 710, validation, refinement, or retraining 712, and deployment 714, or a combination thereof.

For example, data collection and preprocessing 702 can include a phase for acquiring and cleaning data to ensure that it is suitable for use in the machine learning model. This phase may also include removing duplicates, handling missing values, and converting data into a suitable format. Feature engineering 704 can include a phase for selecting and transforming the training data 806 to create features that are useful for predicting the target variable. Feature engineering may include (1) receiving features 808 (e.g., as structured or labeled data in supervised learning) and/or (2) identifying features 808 (e.g., unstructured, or unlabeled data for unsupervised learning) in training data 806. Model selection and training 706 can include a phase for selecting an appropriate machine learning algorithm and training it on the preprocessed data. This phase may further involve splitting the data into training and testing sets, using cross-validation to evaluate the model, and tuning hyperparameters to improve performance.

In additional examples, model evaluation 708 can include a phase for evaluating the performance of a trained model (e.g., the trained machine-learning program 802) on a separate testing dataset. This phase can help determine if the model is overfitting or underfitting and determine whether the model is suitable for deployment. Prediction 710 can include a phase for using a trained model (e.g., trained machine-learning program 802) to generate predictions on new, unseen data. Validation, refinement or retraining 712 can include a phase for updating a model based on feedback generated from the prediction phase, such as new data or user feedback. Deployment 714 can include a phase for integrating the trained model (e.g., the trained machine-learning program 802) into a more extensive system or application, such as a web service, mobile app, or IoT device. This phase can involve setting up APIs, building a user interface, and ensuring that the model is scalable and can handle large volumes of data.

FIG. 8 illustrates further details of two example phases, namely a training phase 804 (e.g., part of the model selection and training 706) and a prediction phase 810 (part of prediction 710). Prior to the training phase 804, feature engineering 704 is used to identify features 808. This may include identifying informative, discriminating, and independent features for effectively operating the trained machine-learning program 802 in pattern recognition, classification, and regression. In some examples, the training data 806 includes labeled data, known for pre-identified features 808 and one or more outcomes. Each of the features 808 may be a variable or attribute, such as an individual measurable property of a process, article, system, or phenomenon represented by a data set (e.g., the training data 806). Features 808 may also be of different types, such as numeric features, strings, and graphs, and may include one or more of content 812, concepts 814, attributes 816, historical data 818, and/or user data 820, merely for example and not limitation.

In training phase 804, the machine-learning pipeline 700 uses the training data 806 to find correlations among the features 808 that affect a predicted outcome or prediction/inference data 820.

With the training data 806 and the identified features 808, the trained machine-learning program 802 is trained during the training phase 804 during machine-learning program training 824. The machine-learning program training 824 appraises values of the features 808 as they correlate to the training data 806. The result of the training is the trained machine-learning program 802 (e.g., a trained or learned model).

Further, the training phase 804 may involve machine learning, in which the training data 806 is structured (e.g., labeled during preprocessing operations). The trained machine-learning program 802 implements a neural network 826 capable of performing, for example, classification and clustering operations. In other examples, the training phase 804 may involve deep learning, in which the training data 806 is unstructured, and the trained machine-learning program 802 implements a deep neural network 826 that can perform both feature extraction and classification/clustering operations.

In some examples, a neural network 826 may be generated during the training phase 804 and implemented within the trained machine-learning program 802. The neural network 826 includes a hierarchical (e.g., layered) organization of neurons, with each layer consisting of multiple neurons or nodes. Neurons in the input layer receive the input data, while neurons in the output layer produce the final output of the network. Between the input and output layers, there may be one or more hidden layers, each consisting of multiple neurons.

Each neuron in the neural network 826 operationally computes a function, such as an activation function, which takes as input the weighted sum of the outputs of the neurons in the previous layer, as well as a bias term. The output of this function is then passed as input to the neurons in the next layer. If the output of the activation function exceeds a certain threshold, an output is communicated from that neuron (e.g., transmitting neuron) to a connected neuron (e.g., receiving neuron) in successive layers. The connections between neurons have associated weights, which define the influence of the input from a transmitting neuron to a receiving neuron. During the training phase, these weights are adjusted by the learning algorithm to optimize the performance of the network. Different types of neural networks may use different activation functions and learning algorithms, affecting their performance on different tasks. The layered organization of neurons and the use of activation functions and weights enable neural networks to model complex relationships between inputs and outputs, and to generalize to new inputs that were not seen during training.

In some examples, the neural network 826 may also be one of several different types of neural networks, such as a single-layer feed-forward network, a Multilayer Perceptron (MLP), an Artificial Neural Network (ANN), a Recurrent Neural Network (RNN), a Long Short-Term Memory Network (LSTM), a Bidirectional Neural Network, a symmetrically connected neural network, a Deep Belief Network (DBN), a Convolutional Neural Network (CNN), a Generative Adversarial Network (GAN), an Autoencoder Neural Network (AE), a Restricted Boltzmann Machine (RBM), a Hopfield Network, a Self-Organizing Map (SOM), a Radial Basis Function Network (RBFN), a Spiking Neural Network (SNN), a Liquid State Machine (LSM), an Echo State Network (ESN), a Neural Turing Machine (NTM), or a Transformer Network, merely for example.

In addition to the training phase 804, a validation phase may be performed on a separate dataset known as the validation dataset. The validation dataset is used to tune the hyperparameters of a model, such as the learning rate and the regularization parameter. The hyperparameters are adjusted to improve the model's performance on the validation dataset.

Once a model is fully trained and validated, in a testing phase, the model may be tested on a new dataset. The testing dataset is used to evaluate the model's performance and ensure that the model has not overfitted the training data.

In prediction phase 810, the trained machine-learning program 802 uses the features 808 for analyzing query data 828 to generate inferences, outcomes, or predictions, as examples of a prediction/inference data 820. For example, during prediction phase 810, the trained machine-learning program 802 generates an output. Query data 828 is provided as an input to the trained machine-learning program 802, and the trained machine-learning program 802 generates the prediction/inference data 822 as output, responsive to receipt of the query data 828.

In some examples, the trained machine-learning program 802 may be a generative AI model. Generative AI is a term that may refer to any type of artificial intelligence that can create new content from training data 806. For example, generative AI can produce text, images, video, audio, code, or synthetic data similar to the original data but not identical.

Some of the techniques that may be used in generative AI are: Convolutional Neural Networks, Recurrent Neural Networks, generative adversarial networks, variational autoencoders, transformer models, and the like. For example, Convolutional Neural Networks (CNNs) can be used for image recognition and computer vision tasks. CNNs may, for example, be designed to extract features from images by using filters or kernels that scan the input image and highlight important patterns. Recurrent Neural Networks (RNNs) can be used for processing sequential data, such as speech, text, and time series data, for example. RNNs employ feedback loops that allow them to capture temporal dependencies and remember past inputs. Generative adversarial networks (GANs) can include two neural networks: a generator and a discriminator. The generator network attempts to create realistic content that can fool the discriminator network, while the discriminator network attempts to distinguish between real and fake content. The generator and discriminator networks compete with each other and improve over time. Variational autoencoders (VAEs) can encode input data into a latent space (e.g., a compressed representation) and then decode it back into output data. The latent space can be manipulated to generate new variations of the output data. VAEs may use self-attention mechanisms to process input data, allowing them to handle long text sequences and capture complex dependencies. Transformer models can use attention mechanisms to learn the relationships between different parts of input data (such as words or pixels) and generate output data based on these relationships. Transformer models can handle sequential data, such as text or speech, as well as non-sequential data, such as images or code. In generative AI examples, the output prediction/inference data 822 can include predictions, translations, summaries, media content, and the like, or some combination thereof.

In some example embodiments, computer-readable files come in several varieties, including unstructured files, semi-structured files, and structured files. These terms may mean different things to different people. Examples of structured files include Variant Call Format (VCF) files, Keithley Data File (KDF) files, Hierarchical Data Format version 5 (HDF5) files, and the like. As known to those of skill in the relevant arts, VCF files are often used in the bioinformatics field for storing, e.g., gene-sequence variations, KDF files are often used in the semiconductor industry for storing, e.g., semiconductor-testing data, and HDF5 files are often used in industries such as the aeronautics industry, in that case for storing data such as aircraft-emissions data.

As used herein, examples of unstructured files include image files, video files, PDFs, audio files, and the like; examples of semi-structured files include JavaScript Object Notation (JSON) files, extensible Markup Language (XML) files, and the like. Numerous other example unstructured-file types, semi-structured-file types, and structured-file types, as well as example uses thereof, could certainly be listed here as well and will be familiar to those of skill in the relevant arts. Different people of skill in the relevant arts may classify types of files differently among these categories and may use one or more different categories instead of or in addition to one or more of these.

Data platforms are widely used for data storage and data access in computing and communication contexts. Concerning architecture, a data platform could be an on-premises data platform, a network-based data platform (e.g., a cloud-based data platform), a combination of the two, and/or include another type of architecture. Concerning the type of data processing, a data platform could implement online analytical processing (OLAP), online transactional processing (OLTP), a combination of the two, and/or another type of data processing. Moreover, a data platform could be or include a relational database management system (RDBMS) and/or one or more other types of database management systems.

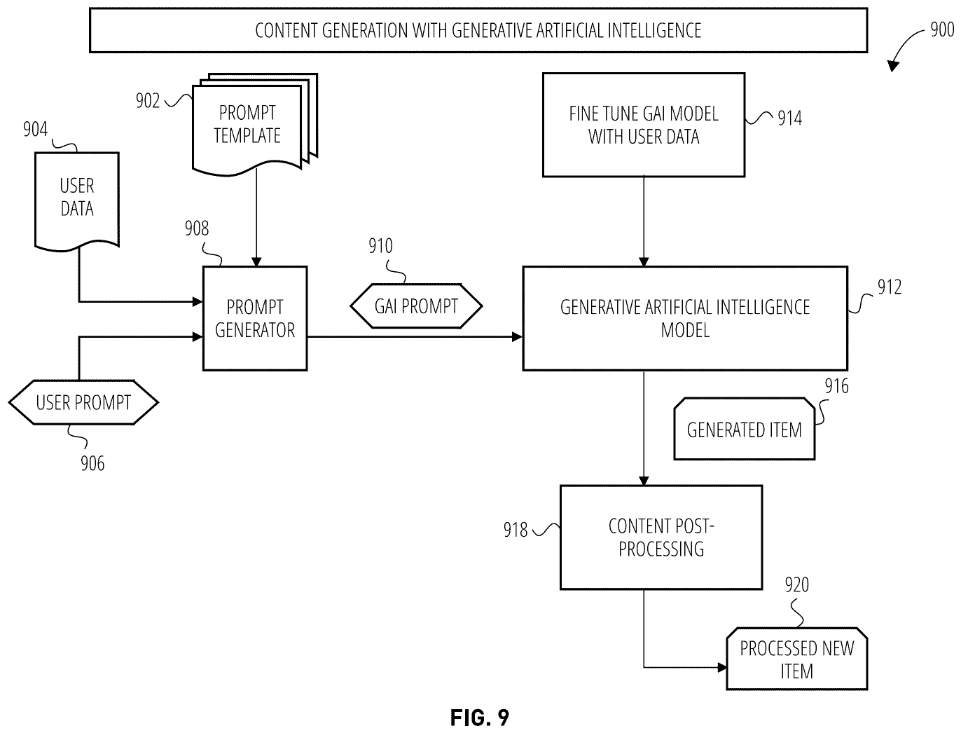

FIG. 9 illustrates a block diagram 900 employing the use of a Generative Artificial Intelligence (GAI) model 912 to generate new content, according to some examples. GAI is a type of AI that can generate new content, such as images, text, video, or audio. The GAI model 912 is trained on large datasets of data and uses this data to learn the patterns and relationships between different elements of the data. There are several types of GAI models, such as Generative Adversarial networks (GANs), Variational Autoencoders (VAEs), and Autoregressive models.

The GAI models generate items of different types, such as GAI models for creating text (e.g., GPT-4, Pathways Language Model 2 (PaLM 2), LaMDA), images (e.g., DALL-E 2, Stable Diffusion), videos (Runway Gen-2, Stable Diffusion Video), audio (e.g., Google MusicLM, Stable Audio), etc.

Often, the companies that create the GAI models make the GAI models available to users who can apply them to generate the desired content based on a GAI prompt 910 provided to the GAI model 912. Users can utilize the GAI model 912 as provided by the vendor or can optionally fine-tune 914 the GAI model 912 with their user data to adjust the parameters of the GAI model 912 in order to improve performance on a specific task or domain.

In some examples, fine-tuning the GAI model 912 includes the following operations: 1. Collect user data: Gather a collection of user data that is relevant to the target task or domain. This data could include text, images, audio, or other types of data; 2. Label the data: if the task requires supervised learning, the user data is labeled with the correct outputs; 3. Select a fine-tuning method. Some of the methods for fine-tuning GAI models include Full fine-tuning, Few-shot fine-tuning, and Prompt-based fine-tuning; 4. Train the GAI model 912: Perform incremental training of the tune 914 using the selected fine-tuning method; and 5. Optionally, evaluate the performance of the fine-tuned model on a held-out dataset.

The GAI model 912 can be used to generate new content based on the GAI prompt 910 used as input, and the GAI model 912 creates a newly generated item 916 as output.

The GAI prompt 910 is a piece of text or code that is used to instruct the GAI model 912 towards generating a desired output (e.g., generated item 916). The GAI prompt 910 provides context, instructions, and expectations for the output. The newly generated item 916 may be multi-modal, such as a piece of text, an image, a video, an audio, a piece of programming code, etc., or a combination thereof.

Prompt engineering is the process of designing and crafting prompts to effectively instruct and guide a GAI model toward generating desired outputs. It involves selecting and structuring the text that forms the GAI prompt 910 input to the GAI model 912, ensuring that the GAI prompt 910 accurately conveys the task, context, and desired style of the output.

A prompt generator 908 is a computer program that generates the GAI prompt 910. There are several ways to generate the GAI prompt 910. In one example, the prompt generator 908 may use a user prompt 906 entered by the user in plain language as the GAI prompt 910. In other examples, the prompt generator 908 creates the GAI prompt 910 without having a user prompt 906, such as by using a static pre-generated prompt based on the desired output.

In other examples, the prompt generator 908 uses a prompt template 902 to generate the GAI prompt 910. The prompt template 902 defines the structure of the GAI prompt 910 and may include fields that may be filled in based on available information to generate the GAI prompt, such as user data 904 or the user prompt 906. The prompt template may also include rules for the creating of the GAI prompt (e.g., include specific text when the recipient resides in California, but do not include the text if the recipient does not reside in California). In other examples, the prompt generator 908 uses heuristics codified into a computer program to generate the GAI prompt 910.

After the generated item 916 is generated, an optional operation 918 of content postprocessing may be performed to modify or block the newly generated item 916, resulting in a processed new item 920. The generated item 916 may be post-processed for various reasons, including improving accuracy and consistency (e.g., checking for factual errors, grammatical mistakes, or inconsistencies in style or format); enhancing quality and relevance (e.g., remove irrelevant or redundant content, improve coherence and flow, ensure that the output aligns with the intended purpose); enhancing output (e.g., polish wording, improve images, ensure that the style matches the desired effect); personalizing the new generated item 916; and ensuring ethical and responsible use.

The generated item 916 is new content, and it does not refer to content that is the result of editing or changing existing material (e.g., editing an image to include text within is not considered GAI-generated new content). One difference between the generated item 916 and material created with editing tools is that the newly generated item 916 is entirely new content, while the editing tool modifies existing content or creates the content one instruction at a time. Another difference is that the GAI model 912 can produce highly creative and imaginative content, while editing tools focus on enhancing the existing content based on user commands. Another difference is that the GAI model 912 can generate content rapidly, while the editing tools require more time and effort for thorough editing and refinement.

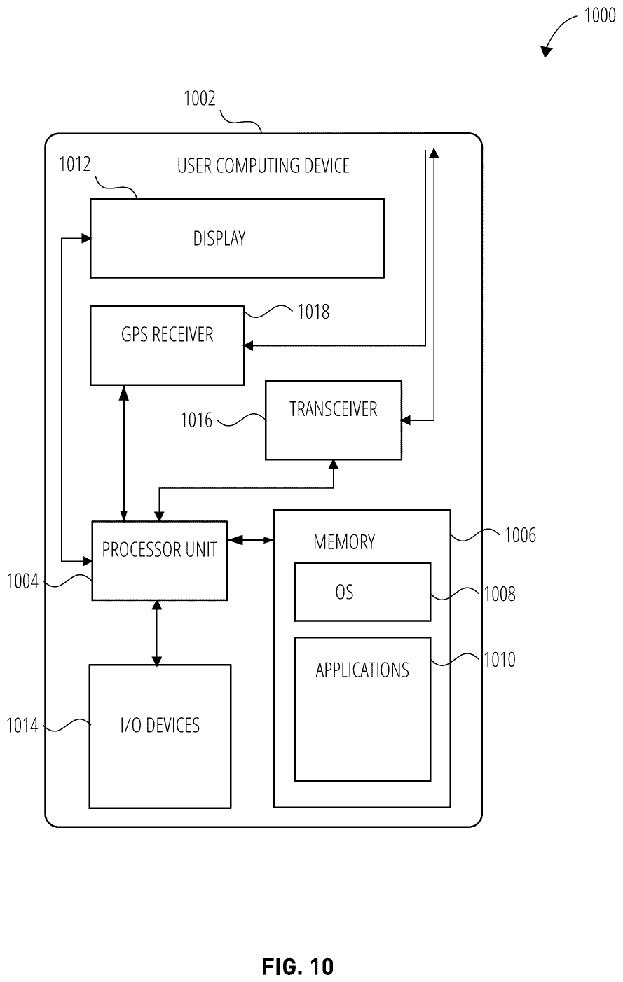

FIG. 10 illustrates a block diagram showing an example architecture 1000 of a user computing device 1002, according to some example embodiments. The architecture 1000 may, for example, describe any of the computing devices described herein, including, for example, the bank branch ATM 103, the mobile device 502, the ATM service 202, the financial services system 206, or components thereof.

The architecture 1000 comprises a processor unit 1004. The processor unit 1004 may include one or more processors. Any of a variety of different types of commercially available processors suitable for computing devices may be used (e.g., an XScale architecture microprocessor, a Microprocessor without Interlocked Pipeline Stages (MIPS) architecture processor, or another type of processor). A memory 1006, such as a Random Access Memory (RAM), a flash memory, or another type of memory or data storage, is typically accessible to the processor unit 1004. The memory 1006 may be adapted to store an operating system (OS) 1008, as well as applications 1010 (e.g., programs).

The processor unit 1004 may be coupled, either directly or via appropriate intermediary hardware, to a display 1012 and to one or more input/output (I/O) devices 1014, such as a keypad, a touch panel sensor, a microphone, and the like. Such i/o devices 1014 may include a touch sensor for capturing fingerprint data, a camera for capturing one or more images of the user, a retina scanner, or any other suitable devices. The i/o devices 1014 may be used to implement I/O channels, as described herein. In some examples, the i/o devices 1014 may also include sensors.

Similarly, in some examples, the processor unit 1004 may be coupled to a transceiver 1016 that interfaces with an antenna (not shown). The transceiver 1016 may be configured to both transmit and receive cellular network signals, wireless data signals, or other types of signals via the antenna (not shown), depending on the nature of the computing device implemented by the architecture. Although one transceiver 1016 is shown, in some examples, the architecture includes additional transceivers. For example, a wireless transceiver may be utilized to communicate according to an IEEE 1202.11 specification, such as Wi-Fi and/or a short-range communication medium. Some short-range communication mediums, such as NFC, may utilize a separate, dedicated transceiver. Further, in some configurations, a Global Positioning System (GPS) receiver 1018 may also make use of the antenna to receive GPS signals. In addition to or instead of the GPS receiver 1018, any suitable location-determining sensor may be included and/or used, including, for example, a Wi-Fi positioning system. In some examples, the architecture (e.g., the processor unit 1004) may also support a hardware interrupt. In response to a hardware interrupt, the processor unit 1004 may pause its processing and execute an interrupt service routine (ISR).

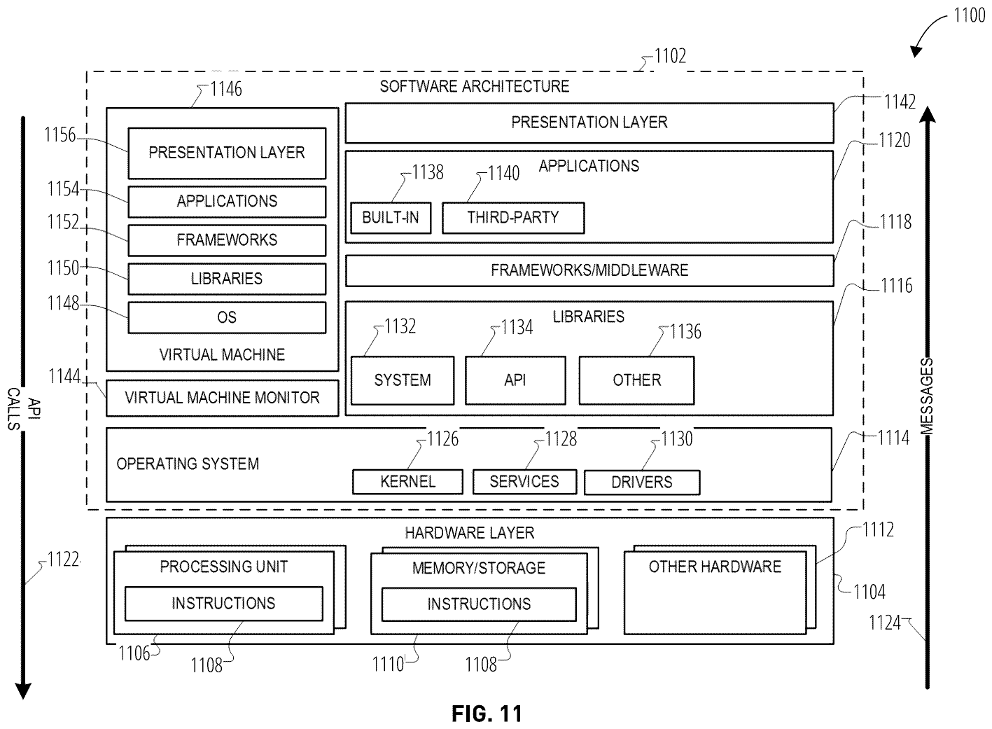

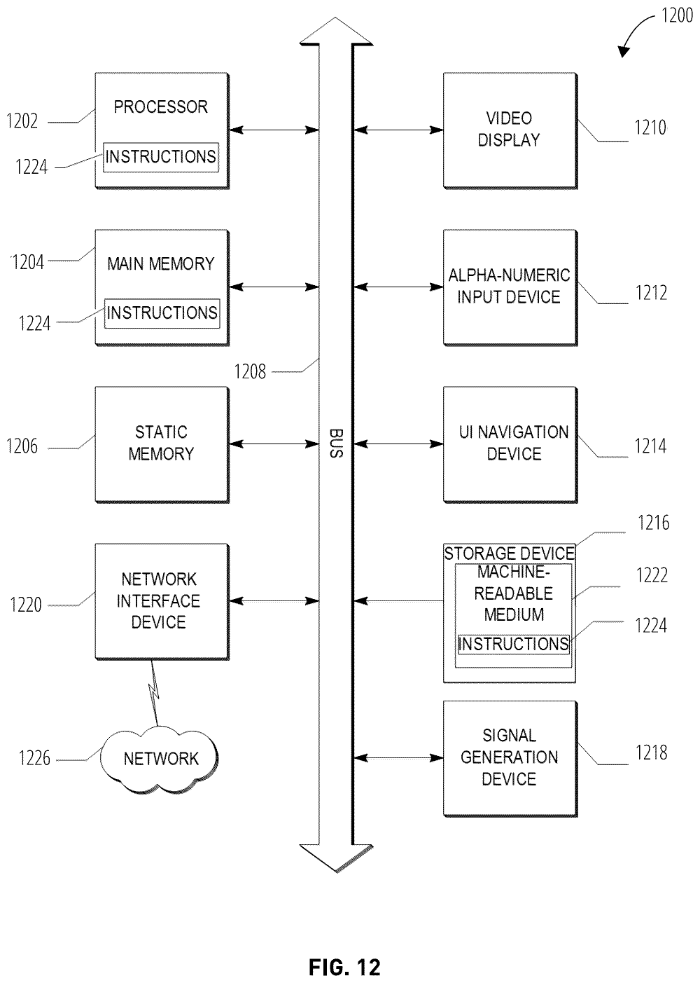

FIG. 11 is a block diagram 1100 showing one example of a processor for a computing device. The software architecture 1102 may be used in conjunction with various hardware architectures, for example, as described herein. FIG. 11 is merely a non-limiting example of a software architecture 1102, and many other architectures may be implemented to facilitate the functionality described herein. A representative hardware layer 1104 is illustrated and can represent, for example, any of the above-referenced computing devices. In some examples, the hardware layer 1104 may be implemented according to an architecture 1200 of FIG. 12 and/or the architecture 1000 of FIG. 10.

The representative hardware layer 1104 comprises one or more processing units 1106 having associated executable instructions 1108. The executable instructions 1108 represent the executable instructions of the software architecture 1102, including implementation of the methods, modules, engines, components, and so forth of FIGS. 1-9. The hardware layer 1104 also includes memory and/or storage modules 1110, which also have the executable instructions 1108. The hardware layer 1104 may also comprise other hardware 1112, which represents any other hardware of the hardware layer 1104, such as the other hardware illustrated as part of the architecture 1200.

In the example architecture of FIG. 11, the software architecture 1102 may be conceptualized as a stack of layers where each layer provides particular functionality. For example, the software architecture 1102 may include layers such as an operating system 1114, libraries 1116, frameworks/middleware 1118, applications 1120, and a presentation layer 1142. Operationally, the applications 1120 and/or other components within the layers may invoke application programming interface (API) 1134 through the software stack and receive a response, returned values, and so forth illustrated as messages 1124 in response to the API calls. The layers illustrated are representative in nature and not all software architectures have all layers. For example, some mobile or special-purpose operating systems may not provide a frameworks/middleware 1118 layer, while others may provide such a layer. Other software architectures may include additional or different layers.

The operating system 1114 may manage hardware resources and provide common services. The operating system 1114 may include, for example, a kernel 1126, services 1128, and drivers 1130. The kernel 1126 may act as an abstraction layer between the hardware and the other software layers. For example, the kernel 1126 may be responsible for memory management, processor management (e.g., scheduling), component management, networking, security settings, and so on. The services 1128 may provide other common services for the other software layers. In some examples, the services 1128 include an interrupt service. The interrupt service may detect the receipt of a hardware or software interrupt and, in response, cause the software architecture 1102 to pause its current processing and execute an ISR when an interrupt is received. The ISR may generate an alert.

The drivers 1130 may be responsible for controlling or interfacing with the underlying hardware. For instance, the drivers 1130 may include display drivers, camera drivers, Bluetooth® drivers, flash memory drivers, serial communication drivers (e.g., Universal Serial Bus (USB) drivers), Wi-Fi® drivers, NFC drivers, audio drivers, power management drivers, and so forth depending on the hardware configuration.

The libraries 1116 may provide a common infrastructure that may be utilized by the applications 1120 and/or other components and/or layers. The libraries 1116 typically provide functionality that allows other software modules to perform tasks in an easier fashion than by interfacing directly with the underlying operating system 1114 functionality (e.g., kernel 1126, services 1128, and/or drivers 1130). The libraries 1116 may include system libraries 1132 (e.g., C standard library) that may provide functions such as memory allocation functions, string manipulation functions, mathematic functions, and the like. In addition, the libraries 1116 may include API libraries 1134 such as media libraries (e.g., libraries to support presentation and manipulation of various media formats such as MPEG4, H.264, MP3, AAC, AMR, JPG, and PNG), graphics libraries (e.g., an OpenGL framework that may be used to render 2D and 3D graphic content on a display), database libraries (e.g., SQLite that may provide various relational database functions), web libraries (e.g., WebKit that may provide web browsing functionality), and the like. The libraries 1116 may also include a wide variety of other libraries 1136 to provide many other APIs to the applications 1120 and other software components/modules.

The frameworks 1118 (also sometimes referred to as middleware) may provide a higher-level common infrastructure that may be utilized by the applications 1120 and/or other software components/modules. For example, the frameworks 1118 may provide various graphical user interface (GUI) functions, high-level resource management, high-level location services, and so forth. The frameworks 1118 may provide a broad spectrum of other APIs that may be utilized by the applications 1120 and/or other software components/modules, some of which may be specific to a particular operating system or platform.

The applications 1120 include built-in applications 1138 and/or third-party applications 1140. Examples of representative built-in applications 1138 may include, but are not limited to, a contacts application, a browser application, a book reader application, a location application, a media application, a messaging application, and/or a game application. The third-party applications 1140 may include any of the built-in applications 1138 as well as a broad assortment of other applications. In a specific example, the third-party application 1140 (e.g., an application developed using the Android™ or iOS™ software development kit (SDK) by an entity other than the vendor of the particular platform) may be mobile software running on a mobile operating system such as iOS™, Android™, Windows® Phone, or other computing device operating systems. In this example, the third-party application 1138 may invoke the API calls 1122 provided by the mobile operating system such as the operating system 1114 to facilitate functionality described herein.

The applications 1120 may utilize built-in operating system functions (e.g., kernel 1126, services 1128, and/or drivers 1130), libraries (e.g., system libraries 1132, API libraries 1134, and other libraries 1136), or frameworks/middleware 1118 to create user interfaces to interact with users of the system. Alternatively, or additionally, in some systems, interactions with a user may occur through a presentation layer, such as the presentation layer 1142. In these systems, the application/module “logic” can be separated from the aspects of the application/module that interact with a user.

Some software architectures utilize virtual machines. For example, systems described herein may be executed utilizing one or more virtual machines executed at one or more server computing machines. In the example of FIG. 11, this is illustrated by a virtual machine 1146. A virtual machine creates a software environment where applications/modules can execute as if they were executing on a hardware computing device. The virtual machine 1146 is hosted by a host operating system (e.g., the operating system 1114) and typically, although not always, has a virtual machine monitor 1144, which manages the operation of the virtual machine 1146 as well as the interface with the host operating system (e.g., the operating system 1114). A software architecture executes within the virtual machine 1146, such as an operating system 1148, libraries 1150, frameworks/middleware 1152, applications 1154, and/or a presentation layer 1156 within the VM 1146. These layers of software architecture executing within the virtual machine 1146 can be the same as corresponding layers previously described or may be different.

FIG. 12 is a block diagram illustrating a computing device hardware architecture 1200, within which a set or sequence of instructions can be executed to cause a machine to perform examples of any one of the methodologies discussed herein. The architecture 1200 may describe, for example, any of the computing devices and/or control circuits described herein.

The architecture 1200 may execute the software architecture 1102 described with respect to FIG. 12. The architecture 1200 may operate as a standalone device or may be connected (e.g., networked) to other machines. In a networked deployment, the architecture 1200 may operate in the capacity of either a server or a client machine in server-client network environments, or it may act as a peer machine in peer-to-peer (or distributed) network environments. The architecture 1200 can be implemented in a personal computer (PC), a tablet PC, a hybrid tablet, a set-top box (STB), a personal digital assistant (PDA), a mobile telephone, a web appliance, a network router, a network switch, a network bridge, or any machine capable of executing instructions (sequential or otherwise) that specify operations to be taken by that machine.

The example architecture 1200 includes a processor unit 1202 comprising at least one processor (e.g., a central processing unit (CPU), a graphics processing unit (GPU), or both, processor cores, compute nodes, etc.). The architecture 1200 may further comprise a main memory 1204 and a static memory 1206, which communicate with each other via a link 1208 (e.g., a bus). The architecture 1200 can further include a video display unit 1210, an alphanumeric input device 1212 (e.g., a keyboard), and a UI navigation device 1214 (e.g., a mouse). In some examples, the video display unit 1210, alphanumeric input device 1212, and UI navigation device 1214 are incorporated into a touchscreen display. The architecture 1200 may additionally include a storage device 1216 (e.g., a drive unit), a signal generation device 1218 (e.g., a speaker), a network interface device 1220, and one or more sensors (not shown), such as a GPS sensor, compass, accelerometer, or other sensor.

In some examples, the processor unit 1202 or another suitable hardware component may support a hardware interrupt. In response to a hardware interrupt, the processor unit 1202 may pause its processing and execute an ISR, for example, as described herein.

The storage device 1216 includes a machine-readable medium 1222 on which is stored one or more sets of data structures and instructions 1224 (e.g., software) embodying or utilized by any one or more of the methodologies or functions described herein. The instructions 1224 can also reside, completely or at least partially, within the main memory 1204, within the static memory 1206, and/or within the processor unit 1202 during execution thereof by the architecture 1200, with the main memory 1204, the static memory 1206, and the processor unit 1202 also constituting machine-readable media. The instructions 1224 stored at the machine-readable medium 1222 may include, for example, instructions for implementing the software architecture 1102, instructions for executing any of the features described herein, etc.

While the machine-readable medium 1222 is illustrated in an example to be a single medium, the term “machine-readable medium” can include a single medium or multiple media (e.g., a centralized or distributed database, and/or associated caches and servers) that store the one or more instructions 1224. The term “machine-readable medium” shall also be taken to include any tangible medium that is capable of storing, encoding, or carrying instructions for execution by the machine and that cause the machine to perform any one or more of the methodologies of the present disclosure, or that is capable of storing, encoding, or carrying data structures utilized by or associated with such instructions. The term “machine-readable medium” shall accordingly be taken to include, but not be limited to, solid-state memories, and optical and magnetic media. Specific examples of machine-readable media include non-volatile memory, including, but not limited to, by way of example, semiconductor memory devices (e.g., electrically programmable read-only memory (EPROM) and electrically crasable programmable read-only memory (EEPROM)) and flash memory devices; magnetic disks such as internal hard disks and removable disks; magneto-optical disks; and CD-ROM and DVD-ROM disks.

The instructions 1224 can further be transmitted or received over a communications network 1226 using a transmission medium via the network interface device 1220 utilizing any one of a number of well-known transfer protocols (e.g., hypertext transfer protocol (HTTP)). Examples of communication networks include a LAN, a WAN, the Internet, mobile telephone networks, plain old telephone service (POTS) networks, and wireless data networks (e.g., Wi-Fi, 3G, 4G, and 5G LTE/LTE-A or WiMAX networks). The term “transmission medium” shall be taken to include any intangible medium that is capable of storing, encoding, or carrying instructions for execution by the machine, and includes digital or analog communications signals or other intangible media to facilitate communication of such software.

The machine in architecture 1200 may be in the form of a personal computer (PC), a tablet PC, a set-top box (STB), a personal digital assistant (PDA), a mobile telephone, a smart phone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate on, logic or a number of components, modules, or mechanisms. Modules are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

The terms “transmission medium” and “signal medium” mean the same thing and may be used interchangeably in this disclosure. The terms “transmission medium” and “signal medium” shall be taken to include any intangible medium that is capable of storing, encoding, or carrying the instructions for execution by the machine, and include digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a manner as to encode information in the signal.

As used herein, the terms “machine-storage medium,” “device-storage medium,” and “computer-storage medium” mean the same thing and may be used interchangeably in this disclosure. The terms refer to a single or multiple storage devices and/or media (e.g., a centralized or distributed database, and/or associated caches and servers) that store executable instructions and/or data. The terms shall accordingly be taken to include, but not be limited to, solid-state memories, and optical and magnetic media, including memory internal or external to processors. Specific examples of machine-storage media, computer-storage media, and/or device-storage media include non-volatile memory, including by way of example semiconductor memory devices, (e.g., erasable programmable read-only memory (EPROM), electrically crasable programmable read-only memory (EEPROM), field-programmable gate arrays (FPGAs), and flash memory devices); magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

The terms “machine-readable medium,” “computer-readable medium,” and “device-readable medium” mean the same thing and may be used interchangeably in this disclosure. The terms are defined to include both machine-storage media and transmission media. Thus, the terms include both storage devices/media and carrier waves/modulated data signals.

The various operations of example methods described herein may be performed, at least partially, by one or more processors that are temporarily configured (e.g., by software) or permanently configured to perform the relevant operations. Similarly, the methods described herein may be at least partially processor implemented. For example, at least some of the operations of the methods described herein may be performed by one or more processors. The performance of certain of the operations may be distributed among the one or more processors, not only residing within a single machine, but also deployed across a number of machines. In some example embodiments, the processor or processors may be located in a single location (e.g., within a home environment, an office environment, or a server farm), while in other embodiments the processors may be distributed across a number of locations.

Although the embodiments of the present disclosure have been described with reference to specific example embodiments, it will be evident that various modifications and changes may be made to these embodiments without departing from the broader scope of the inventive subject matter. Accordingly, the specification and drawings are to be regarded in an illustrative rather than a restrictive sense. The accompanying drawings that form a part hercof show, by way of illustration, and not of limitation, specific embodiments in which the subject matter may be practiced. The embodiments illustrated are described in sufficient detail to enable those skilled in the art to practice the teachings disclosed herein. Other embodiments may be used and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art, upon reviewing the above description.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended; that is, a system, device, article, or process that includes elements in addition to those listed after such a term in a claim is still deemed to fall within the scope of that claim.

Also, in the above Detailed Description, various features can be grouped together to streamline the disclosure. However, the claims cannot set forth every feature disclosed herein, as embodiments can feature a subset of said features. Further, embodiments can include fewer features than those disclosed in a particular example. Thus, the following claims are hereby incorporated into the Detailed Description, with each claim standing on its own as a separate embodiment. The scope of the embodiments disclosed herein is to be determined with reference to the appended claims, along with the full scope of equivalents to which such claims are entitled.

What is claimed is:

1. A system for selecting a location for automated teller machine (ATM) placement using one or more artificial intelligence (AI) models, the system comprising:
one or more hardware processors of a machine; and
at least one memory storing instructions that, when executed by the one or more hardware processors, cause the system to perform operations comprising:
collecting ATM usage data;
integrating the collected ATM usage data with external data associated with a zip code of an ATM user to generate integrated data for use by the one or more AI models, the external data received from outside a financial institution associated with an ATM;
analyzing, by the one or more machine learning models, the integrated data, the analyzing comprising predictive identification for an updated ATM distribution point by the one or more AI models; and
generating an output comprising the updated ATM distribution point.

2. The system of claim 1, wherein collecting the ATM usage data further comprises:
collecting the external data from a plurality of external data sources comprising at least one of demographic data, real estate availability data, foot traffic pattern data, economic indicator data, or a partner store location.

3. The system of claim 1, the operations further comprising:
identifying customer ATM traffic patterns associated with existing ATM distribution points;
identifying a potential partner store location;
associating the customer ATM traffic patterns with the potential partner store location; and
recommending, based on the associating, the potential partner store location for placement of the updated ATM distribution point based on the customer ATM traffic patterns.

4. The system of claim 1, the operations further comprising:
employing predictive analytics to forecast demographic and economic changes affecting a potential ATM distribution point among a plurality of existing ATM distribution points; and
combining the predictive analytics and the integrated data to identify an optimal ATM distribution point based on the forecasted demographic and economic changes.

5. The system of claim 4, the operations further comprising:
scoring the potential ATM distribution point, the scoring comprising utilizing multi-criteria decision analysis to predict the optimal ATM distribution point.

6. The system of claim 5, the operations further comprising:
monitoring the plurality of existing ATM distribution points to identify peak usage times;
associating the peak usage times with customer wait times; and
adjusting the scoring of the potential ATM distribution point based on the associating.

7. The system of claim 1, wherein the generating the output comprising the updated ATM distribution point further comprises:
employing an econometric model to estimate potential construction costs based on regional economic data associated with the updated ATM distribution point.

8. The system of claim 1, the operations further comprising:
providing a user interface to enable an operator of the financial institution to adjust the updated ATM distribution point based on qualitative data received by the financial institution.

9. The system of claim 1, wherein generating the output further comprises:
monitoring a plurality of metrics associated with the ATM usage data in near real-time; and
generating a data visualization for conveying a plurality of geo-spatial patterns associated with the updated ATM distribution point based on at least one of the plurality of metrics.

10. The system of claim 1, the operations further comprising:
identifying an underperforming existing ATM distribution point; and
recommending removal of the underperforming existing ATM distribution point.

11. A computer-implemented method for selecting a location for automated teller machine (ATM) placement using one or more artificial intelligence (AI) models, the method comprising:
collecting, by at least one hardware processor, ATM usage data;
integrating the collected ATM usage data with external data associated with a zip code of an ATM user to generate integrated data for use by the one or more AI models, the external data received from outside a financial institution associated with an ATM;
analyzing, by the one or more AI models, the integrated data, the analyzing comprising predictive identification for an updated ATM distribution point by the one or more AI models; and
generating an output comprising the updated ATM distribution point.

12. The method of claim 11, wherein collecting the ATM usage data further comprises:
collecting the external data from a plurality of external data sources comprising at least one of demographic data, real estate availability data, foot traffic pattern data, economic indicator data, or a partner store location.

13. The method of claim 11, further comprising:
identifying customer ATM traffic patterns associated with existing ATM distribution points;
identifying a potential partner store location;
associating the customer ATM traffic patterns with the potential partner store location; and
recommending, based on the associating, the potential partner store location for placement of the updated ATM distribution point based on the customer ATM traffic patterns.

14. The method of claim 11, further comprising:
employing predictive analytics to forecast demographic and economic changes affecting a potential ATM distribution point among a plurality of existing ATM distribution points; and
combining the predictive analytics and the integrated data to identify an optimal ATM distribution point based on the forecasted demographic and economic changes.

15. The method of claim 14, further comprising:
scoring the potential ATM distribution point, the scoring comprising utilizing multi-criteria decision analysis to predict the optimal ATM distribution point.

16. The method of claim 15, further comprising:
monitoring the plurality of existing ATM distribution points to identify peak usage times;
associating the peak usage times with customer wait times; and
adjusting the scoring of the potential ATM distribution point based on the associating.

17. The method of claim 11, wherein the generating the output comprising the updated ATM distribution point further comprises:
employing an econometric model to estimate potential construction costs based on regional economic data associated with the updated ATM distribution point.

18. The method of claim 11, further comprising:
providing a user interface to enable an operator of the financial institution to adjust the updated ATM distribution point based on qualitative data received by the financial institution.

19. The method of claim 11, wherein generating the output further comprises:
monitoring a plurality of metrics associated with the ATM usage data in near real-time; and
generating a data visualization for conveying a plurality of geo-spatial patterns associated with the updated ATM distribution point based on at least one of the plurality of metrics.

20. The method of claim 11, further comprising:
identifying an underperforming existing ATM distribution point; and
recommending removal of the underperforming existing ATM distribution point.

21. A machine-storage medium comprising instructions, which when executed by one or more artificial intelligence (AI) models on a computer, cause the one or more AI models to perform operations for selecting a location for automated teller machine (ATM) placement, the operations comprising:
collecting ATM usage data;
integrating the collected ATM usage data with external data associated with a zip code of an ATM user to generate integrated data for use by the one or more AI models, the external data received from outside a financial institution associated with the ATM;
analyzing, by the one or more AI models, the integrated data. the analyzing comprising predictive identification for an updated ATM distribution point by the one or more AI models; and
generating an output comprising the updated ATM distribution point.
